(19) United States
(12) Patent Application Publication
(10) Pub. No.: US 2026/0101000 A1
(43) Pub. Date: Apr. 9, 2026

(54) Electronic Devices and Corresponding Methods for Triggering a Notification Summarization Operation

(71) Applicant: Motorola Mobility LLC, Chicago, IL (US)

(72) Inventors: Vineet Vivekanand Angadi, Dharwad (IN); Vijayakumar GN, Bangalore (IN); Ashwin Kumar Manmohan Pathmudi, Pune (IN); Amit Kumar Agrawal, Bangalore (IN)

(21) Appl. No.: 18/911,057

(22) Filed: Oct. 9, 2024

(51) Int. Cl. H04M 1/72448

(52) U.S. Cl. CPC H04M 1/72448

(57) ABSTRACT

An electronic device detects a first state of the device and a second state of a user interacting with the device using one or more sensors. The device determines whether the first state meets at least a first criterion and whether the second state meets at least a second criterion. When both criteria are met, the device triggers a notification summarization operation. This operation collects and summarizes notifications received during the specified states, optionally assigning prioritization weights based on the importance of each notification. The summarized notifications are presented on the user interface when the device exits the predefined states. The system ensures users receive important notifications in a concise format, minimizing distractions during activities such as exercising or when the device is in a non-handheld mode.

### BACKGROUND

TECHNICAL FIELD This disclosure relates generally to electronic devices, and more particularly to electronic devices having user interfaces.

BACKGROUND ART Users often face challenges in managing alerts presented by an electronic device when they are unable to interact with the electronic device directly. Situations such as exercising, driving, or when the device is in a non-handheld mode can prevent users from promptly viewing and responding to alerts. This can lead to missed important communications and an overwhelming backlog of alerts when the user is able to check. It would be advantageous to have improved electronic devices and corresponding methods for alert management.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one or more method steps in accordance with one or more embodiments of the disclosure.

FIG. 2 illustrates one explanatory electronic device in accordance with one or more embodiments of the disclosure.

FIG. 3 illustrates one explanatory method in accordance with one or more embodiments of the disclosure.

FIG. 4 illustrates another explanatory method in accordance with one or more embodiments of the disclosure.

FIG. 5 illustrates yet another explanatory method in accordance with one or more embodiments of the disclosure.

FIG. 6 illustrates still another explanatory method in accordance with one or more embodiments of the disclosure.

FIG. 7 illustrates one or more method steps in accordance with one or more embodiments of the disclosure.

FIG. 8 illustrates one or more embodiments of the disclosure.

FIG. 9 illustrates a prior art method.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to detecting, by one or more sensors of an electronic device, a first state of the electronic device and a second state of a user interacting with the electronic device, determining, by one or more processors of the electronic device, whether the first state meets at least a first criterion and whether the second state meets at least a second criterion, and, when the first state meets the at least a first criterion and the second state meets the at least a second criterion, triggering, by the one or more processors, a notification summarization operation within the electronic device. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in response to the one or more sensors detecting a predefined state of the electronic device, collecting notification data and summarizing the notification data to generate summarized notifications while the predefined state is occurring, while causing the user interface to present the summarized notifications when occurrence of the predefined state ceases as described herein. The non-processor circuits may include, but are not limited to, a radio receiver, a radio transmitter, signal drivers, clock circuits, power source circuits, and user input devices.

As such, these functions may be interpreted as steps of a method to perform detecting, by one or more sensors of the electronic device, a first state of the electronic device and a second state of a user interacting with the electronic device, determining, by one or more processors of the electronic device, whether the first state meets at least a first criterion and whether the second state meets at least a second criterion, and triggering, by the one or more processors, an artificial intelligence (AI)-based notification summarization operation within the electronic device when the first state meets the at least a first criterion and the second state meets the at least a second criterion. The method can also perform collecting, by the one or more processors, notification data received by the electronic device during the AI-based notification summarization operation, summarizing, by the one or more processors, collected notification data to generate summarized notifications, and presenting, by the one or more processors, the summarized notifications on a user interface of the electronic device when the first state ceases to meet the at least a first criterion and/or the second state ceases to meet the at least a second criterion.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on. ” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure contemplate that modern electronic devices encompass a wide range of gadgets designed to perform specific tasks through electronic circuits and components. These devices include smartphones, tablets, wearable devices, and other portable electronics. They typically feature user interfaces that allow users to interact with the device, receive notifications, and manage various functions. Applications of electronic devices span communication, entertainment, productivity, health monitoring, and more.

Embodiments of the disclosure also contemplate that users often seek to balance their interaction with electronic devices and their engagement with the surrounding environment. This balance involves managing notifications and alerts without being constantly tethered to the device. Illustrating by example, embodiments of the disclosure contemplate that users desire to stay informed about important communications while minimizing distractions during activities such as exercising, driving, or engaging in social interactions. Embodiments of the disclosure contemplate that a goal of such users is to achieve a seamless integration of technology into daily life without compromising attention to immediate surroundings.

Achieving this balance presents several challenges. Users may miss important notifications when they are unable to interact with their devices directly. Situations such as exercising, driving, or when the device is in a non-handheld mode can prevent users from promptly viewing and responding to alerts. This can lead to an overwhelming backlog of notifications, causing frustration and information overload when the user is finally able to check the device.

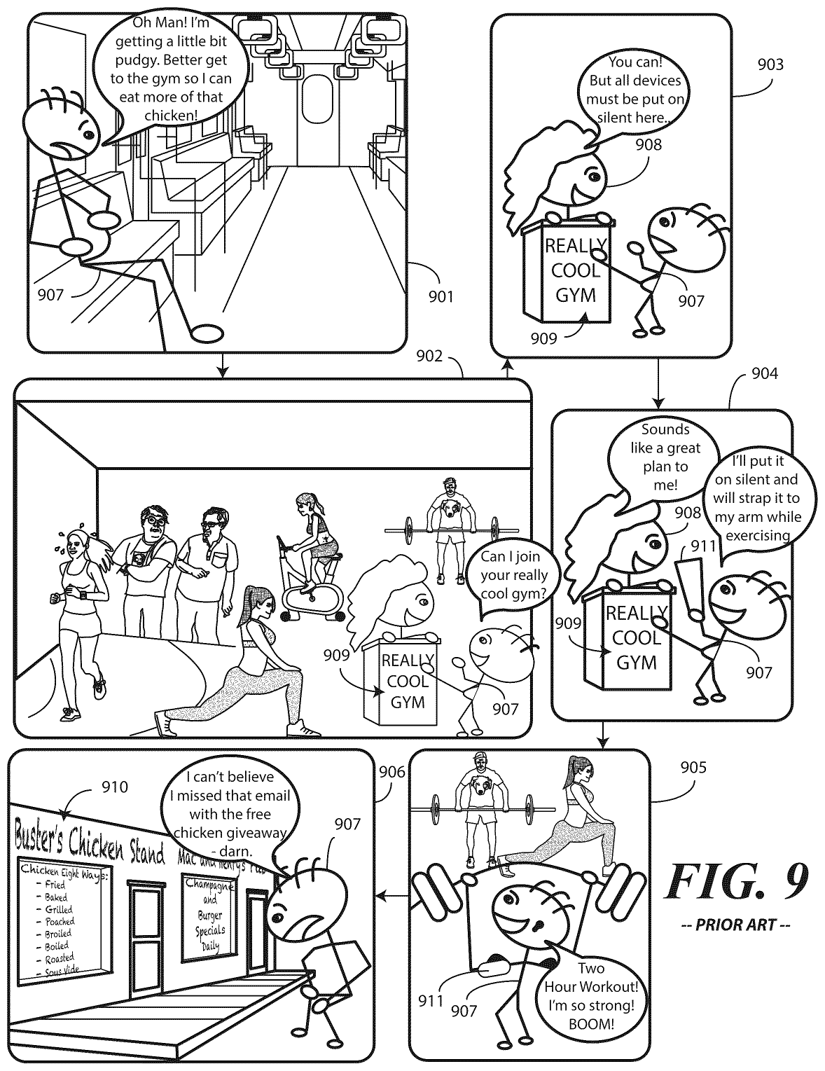

To illustrate how this can occur, turn briefly to FIG. 9, where a prior art method is shown. Beginning at step 901, the (once) ever so svelte Chuck 907 has developed a new habit of stopping by the world famous Buster's Chicken Stand 910 for some of its exceptionally good chicken, which is served eight different ways. Buster's Chicken Stand 910 is located next to the equally famous Mac and Henry's Pub, where Champagne and burgers are served daily as a local favorite specialty.

Poor Chuck 907 has become addicted to the chicken. Alas, he has been eating it daily - sometimes twice daily-for some time. Indeed, this has become not just a habit, but more of a daily ritual.

Unfortunately, devouring Buster's delicious chicken is not without its unintended consequences. As shown at step 901, when Chuck 907 is on the train ride home, he notices he's a little thicker than normal. Not being one to sit on his laurels (or extra pounds), Chuck 907 immediately makes a new resolution to join a gym.

At step 902, Chuck 907 heads to the nearest “Really Cool Gym” 909 and asks to join. As shown at step 903, the ever so friendly staff 908 responds in the affirmative, with a caveat. Since so many people in the gym like to exercise, noise from electronic devices is exclusively prohibited. Accordingly, the ever so friendly staff 908 indicates that “all devices must be pit on silent”at the Really Cool Gym 908.

Chuck 907 has no problem with this requirement, since he really wants to regain his svelte physique. At step 904 he tells the ever so friendly staff 908 of the Really Cool Gym 909 that he will simply strap his smartphone 911 to his arm while exercising. Chuck 907 has a strap with a pocket into which the smartphone 911 can be placed so that it is “out of sight, out of mind”as the saying goes.

Chuck 907 then heads inside the Really Cool Gym 909 at step 905 with his smartphone strapped to his arm. He then proceeds to just crush it with the weights in his workout. Chuck 907 feels so great that he exclaims, during his two hour workout, that he's indeed “so strong.”

Sadly, an unfortunate turn of events has occurred during Chuck's workout. Buster's Chicken Stand 910 had a free giveaway for its VIP customers, one of which Chuck 907 happens to be. With the smartphone 911 strapped to his arm, he completely missed the alert announcing this once in a lifetime chicken giveaway. Not only did he miss this notification, since the smartphone 911 had to be placed on silent, with its display covered by the arm sleeve, he has missed a plethora of notifications while working out. Crestfallen and downtrodden, Chuck 907 stumbles back to Buster's Chicken Shack 910 at step 906 for more (not for free) chicken and self-contemplation about how he could have avoided this frustrating situation if he'd only known about the offer earlier.

Sadly, situations such as Chuck's are all too common. In an age where users continue to desire to “disconnect” so as to dictate how and when they engage with their electronic devices, they do not want to miss important messages and notifications. While it is known that various methods exist to manage notifications on electronic devices, examples of which include notification summaries, do-not-disturb modes, and wearable devices that provide limited notification access, these solutions often fall short in dynamically adapting to the user's state and the device's state. They may not effectively prioritize notifications based on the user's context or provide a streamlined way to catch up on missed notifications.

Fortunately, embodiments of the disclosure provide a solution to these problems. Embodiments of the disclosure provide improved electronic devices and corresponding methods that can dynamically detect the user's state and the device's state to trigger a notification summarization operation. Advantageously, embodiments of the disclosure enable users to stay informed about important communications while minimizing distractions and managing notifications more effectively.

In one or more embodiments, a method in an electronic device involves detecting, by one or more sensors of the electronic device, a first state of the electronic device and a second state of a user interacting with the electronic device. The method further includes determining, by one or more processors of the electronic device, whether the first state meets at least a first criterion and whether the second state meets at least a second criterion. In one or more embodiments, when the first state meets the at least a first criterion and the second state meets the at least a second criterion, the method triggers actuation, by the one or more processors, of a notification summarization operation within the electronic device.

Illustrating by example, in one or more embodiments the notification summarization operation collects and summarizes notifications received by a communication device of the electronic device while the first state meets the at least a first criterion and the second state meets the at least a second criterion. In some embodiments, the notification summarization operation further assigns a prioritization weight to each notification of the notifications received by the communication device of the electronic device while the first state meets the at least a first criterion and the second state meets the at least a second criterion.

Advantageously, by detecting both a first state of the electronic device and a second state of a user interacting with the device, the method ensures that the notification summarization operation is only triggered when specific conditions are met. This dual-state detection allows for a more contextually aware and relevant summarization process, reducing unnecessary interruptions and ensuring that the user receives a concise summary of notifications only when it is most appropriate.

The physical arrangement of sensors and processors within the electronic device enables the detection of various states, such as the device being in a non-handheld mode, or the user being engaged in physical activity. This arrangement ensures that the device can accurately determine when the user is unable to interact with the device directly, thereby triggering the summarization operation at the right moments.

Compared to existing solutions that may only consider a single state (either user or device), this method's novelty lies in its ability to consider both states simultaneously. This dual-state approach provides a more refined and accurate mechanism for managing notifications, ensuring that users do not miss important communications while minimizing distractions during activities where direct interaction with the device is not feasible.

In practical application, this method can be implemented in scenarios such as when the user is exercising with the device strapped to their arm, driving, or when the device is in a pocket or a non-handheld mode. The method ensures that users receive a summarized notification digest when they are able to check their device, thereby solving the problem of information overload and missed important notifications.

In one or more embodiments, one or more sensors of an electronic device detect a predefined device state. The one or more processors of the electronic device, in response to the one or more sensors detecting the predefined device state, can then collect notification data and summarize the notification data to generate summarized notifications while the predefined device state is occurring.

In one or more embodiments, the one or more processors cause the user interface to present the summarized notifications when occurrence of the predefined device state ceases as detected by the one or more sensors. The predefined device state may include conditions such as the electronic device being positioned in a pocket, transitioning to a wearable state, or being in a low-light environment.

In one or more embodiments, the one or more processors prioritize the notification data by assigning a prioritization weight to each notification, with the prioritization weight being a function of the importance of each notification to a user interacting with the user interface of the electronic device. The one or more processors can optionally terminate the generation of the summarized notifications when the electronic device exits the predefined device state and present the summarized notifications on the user interface when the electronic device enters another predefined device state that is different from the predefined device state.

Advantageously, the arrangement of one or more sensors and one or more processors within the electronic device allows for the detection of a predefined device state, such as the device being positioned in a pocket, transitioning to a wearable state, or being in a low-light environment. This configuration ensures that the device can accurately determine when the user is unable to interact with the device directly, thereby triggering the summarization operation at the right moments.

By collecting notification data and summarizing it to generate summarized notifications while the predefined device state is occurring, the electronic device reduces the cognitive load on the user. This is particularly beneficial in scenarios where the user cannot easily access the device, such as when it is in a pocket or in a wearable state. The summarization ensures that the user receives a concise and prioritized digest of notifications, which can be quickly reviewed when the predefined device state ceases.

Accordingly, in one or more embodiments the electronic device can provide a more contextually aware and relevant summarization process compared to existing solutions that may only consider a single state. The dual-state detection mechanism ensures that the notification summarization operation is only triggered when specific conditions are met, reducing unnecessary interruptions and ensuring that the user receives important notifications in a timely manner.

For example, when the device is in a pocket, the sensors detect this state, and the processors begin summarizing incoming notifications. Once the device is removed from the pocket, the user interface presents the summarized notifications, allowing the user to quickly catch up on important communications without being overwhelmed by a flood of individual notifications.

In some embodiments, an automatic artificial intelligence (AI)-based notification summarization system operates based on both the user state and device state. Illustrating by example, in one or more embodiments the system detects specific user states, such as physical activities like walking or running, low ambient light conditions, and proximity to the device. In one or more embodiments, the system also monitors device states, including bendable configurations, adaptive display modes, and enclosed conditions like being in a pocket.

Upon detecting these states, the system initiates a notification summarization process. For instance, when the device detects that the device is in a non-handheld mode, such as being worn on the wrist or placed in a pocket, the system can begin collecting incoming notifications. In one or more embodiments, AI-based text summarization models then process these notifications, creating a prioritized and concise summary. This summary can then be tailored to the user's context, ensuring that only the relevant information is presented. In one or more embodiments, the system continues to update the summary in real-time as new notifications arrive.

Once the user returns to a state where they can interact with the device, such as switching the device back to full mode or entering a well-lit area, in one or more embodiments the system presents the summarized notifications. This approach minimizes information overload and ensures that users can quickly catch up on important communications without being overwhelmed by a flood of individual notifications. The system's ability to dynamically adapt to both user and device states provides a seamless and efficient notification management experience.

Thus, while users often face challenges in managing alerts presented by an electronic device when they are unable to interact with the electronic device directly, which can lead to missed important communications and an overwhelming backlog of alerts when the user is able to finally check, embodiments of the disclosure advantageously allow users to stay informed about important communications while minimizing distractions during activities such as exercising, driving, or engaging in social interactions. Advantageously, embodiments of the disclosure thus allow users to achieve a balance between staying informed and minimizing distractions presents several challenges.

Existing solutions for managing notifications on electronic devices include notification summaries, do-not-disturb modes, and wearable devices that provide limited notification access. However, these solutions often fall short in dynamically adapting to the user's state and the device's state. They may not effectively prioritize notifications based on the user's context or provide a streamlined way to catch up on missed notifications. These methods may only consider a single state (either user or device), which can result in unnecessary interruptions or missed important communications.

Accordingly, embodiments of the disclosure provide an improved approach to managing notifications by dynamically detecting both the user's state and the device's state to trigger a notification summarization operation. This dual-state detection ensures that the notification summarization operation is only triggered when specific conditions are met, reducing unnecessary interruptions and ensuring that the user receives a concise summary of notifications when the timing is most appropriate. The system collects and summarizes notifications received by the electronic device while the predefined states are occurring and presents the summarized notifications when the user is able to interact with the device. This approach minimizes information overload and ensures that users can quickly catch up on important communications without being overwhelmed by a flood of individual notifications.

In one or more embodiments, a method in an electronic device involves detecting, by one or more sensors of the electronic device, a first state of the electronic device and a second state of a user interacting with the electronic device. The method further includes determining, by one or more processors of the electronic device, whether the first state meets at least a first criterion and whether the second state meets at least a second criterion.

In one or more embodiments, upon meeting these criteria, the method triggers an artificial intelligence (AI)-based notification summarization operation within the electronic device. The method also involves collecting, by the one or more processors, notification data received by the electronic device during the AI-based notification summarization operation, summarizing the collected notification data to generate summarized notifications, and presenting the summarized notifications on a user interface of the electronic device when the first state ceases to meet the at least a first criterion and/or the second state ceases to meet the at least a second criterion.

In one or more embodiments, the first state comprises the electronic device being transported in a wearable configuration, and the second state comprises the user being engaged in physical activity. The sensors detect the wearable configuration of the device, such as being strapped to the user's arm or worn on the wrist. Simultaneously, the sensors monitor the user's physical activity, such as walking or running.

In one or more embodiments, when both conditions are met, the AI-based notification summarization operation is triggered. This operation collects incoming notifications, processes them using AI models to create a concise summary, and assigns prioritization weights based on the importance of each notification. The summarized notifications are then presented to the user when the device is no longer in the wearable configuration or when the user ceases the physical activity, ensuring that the user receives important updates without being overwhelmed by a flood of individual notifications.

By detecting both the state of the electronic device being transported in a wearable configuration and the user being engaged in physical activity, the method ensures that the notification summarization operation is only triggered when specific conditions are met. This dual-state detection allows for a more contextually aware and relevant summarization process, reducing unnecessary interruptions and ensuring that the user receives a concise summary of notifications only when it is most appropriate.

Compared to existing solutions that may only consider a single state (either user or device), this method's novelty lies in its ability to consider both states simultaneously. This dual-state approach provides a more refined and accurate mechanism for managing notifications, ensuring that users do not miss important communications while minimizing distractions during activities where direct interaction with the device is not feasible.

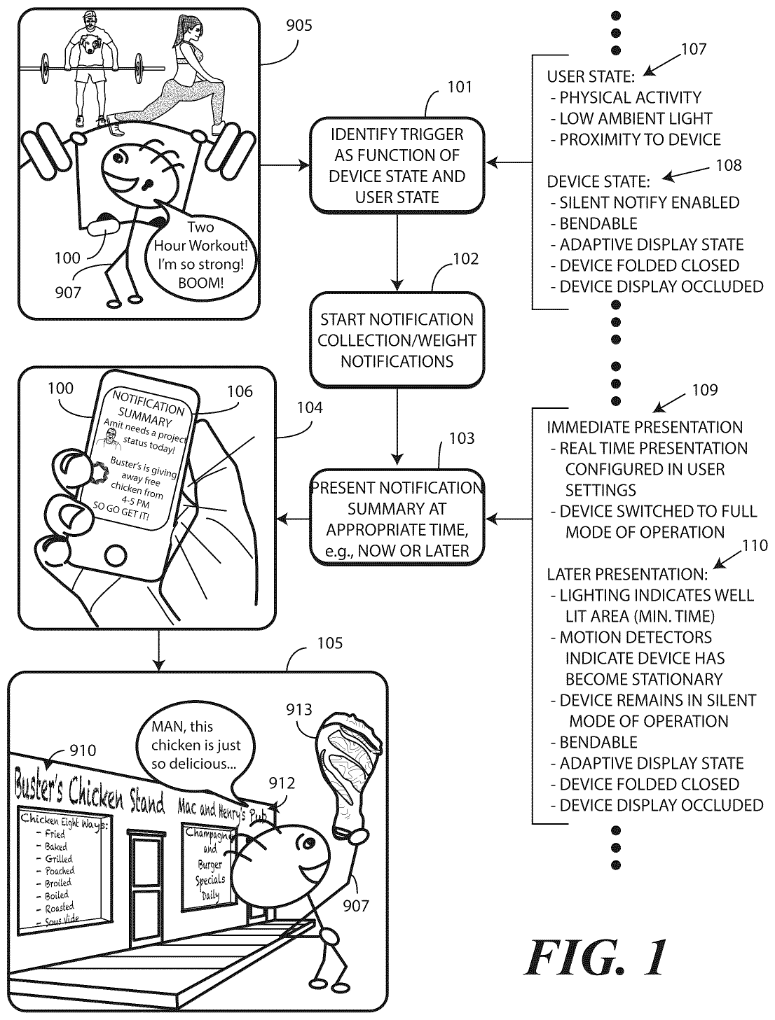

In practical application, this method can be implemented in scenarios such as when the user is exercising with the device strapped to their arm or worn on the wrist. The method ensures that users receive a summarized notification digest when they are able to check their device, thereby solving the problem of information overload and missed important notifications To see just how embodiments of the disclosure can work, turn now to FIG. 1 where Chuck 907 is again working out at the Really Cool Gym at step 905. Once again, in accordance with the strict regulations of the Really Cool Gym, Chuck's electronic device 100 (again a smartphone) is strapped to his arm. However, in FIG. 1, rather than using a prior art smartphone (911), Chuck's electronic device 100 is configured in accordance with embodiments of the disclosure.

At step 101, one or more sensors of the electronic device 100 identify a notification summarization operation as a function of two states, namely, a user state 107 and a device state 108. Examples of the user state 107 include when the user (here, Chuck 907) is engaged in physical activity such as exercise and when the user is in a low-light environment, as would be the case if the user was sleeping or watching a movie. In one or more embodiments, the user state 107 describes the dynamic condition of a user using an electronic device 100 in relation to their environment and context. It encompasses various internal and external factors that influence their interaction with the device and their overall experience.

Another example of a user state 107 would be whether the user is proximately located with the electronic device 100. Illustrating by example, if the user were far away from the electronic device 100, this might trigger the notification summarization operation since the display of the electronic device 100 would not be visible. In another situation, such as is the case with Chuck 907 at step 905, the display may be abutting his skin in a “tethered to the arm” configuration where it cannot be seen. As such, embodiments of the disclosure contemplate that it may be beneficial to trigger the notification summarization operation. It should be noted that these examples of user states 107 are illustrative only, as others will be obvious to those of ordinary skill in the art having the benefit of this disclosure.

In one or more embodiments, the device state 108 encapsulates the dynamic condition of the electronic device 100 at a particular point in time, including its display characteristics and physical shape. In one or more embodiments, the device state 108 encompasses various internal and external factors that influence the device's functionality and behavior.

Examples of the device state 108 include whether alerts associated with notifications are silenced and when the display of the electronic device 100 is occluded, as is the case at step 905. In some embodiments, such as where the electronic device 100 comprises a first device housing that is pivotable about a hinge relative to a second device housing between a closed position and an axially displaced open position, the device state 108 can comprise the first device housing and second device housing being pivoted to the closed position. In still other embodiments, the device state 108 can comprise an adaptive display mode of operation being enabled. Other examples of device states 108 will be obvious to those of ordinary skill in the art having the benefit of this disclosure.

In effect, at step 101 one or more sensors of the electronic device 100 detect a first state of the electronic device 100 and a second state of the user interacting with the electronic device 100. Here, the first state of the electronic device 100 is the fact that the electronic device 100 is situated within a sleeve and strapped to Chuck's arm, while the second state of Chuck 907 is the fact that Chuck 907 is exercising. In one or more embodiments, step 101 can also include one or more processors of the electronic device 100 determining whether the first state of the user meets at least a first criterion and the second state of the electronic device 100 meets at least a second criterion.

In one or more embodiments, the at least a first criterion comprises one or more of a first device housing of the electronic device being pivoted relative to a second device housing to a closed position, a display of the electronic device being placed in an adaptive display mode of operation, the electronic device being placed in a low-ambient light environment, the electronic device being in an enclosed condition, and/or the display of the electronic device being occluded by an object situated proximately with the display of the electronic device. In one or more embodiments, the at least a first criterion comprises the electronic device being positioned in a pocket. Other first criteria will be obvious to those of ordinary skill in the art having the benefit of this disclosure.

In one or more embodiments, the second criterion comprises one or more of the user engaging in physical activity or a lack of proximity with the electronic device 100 for at least a predefined duration, one example of which is ten minutes. Other examples of second criteria will be obvious to those of ordinary skill in the art having the benefit of this disclosure.

At step 102, when the first state meets the at least a first criterion and the second state meets the at least a second criterion, the one or more processors trigger actuation of a notification summarization operation within the electronic device 100. In one or more embodiments, the notification summarization operation collects notifications and, optionally using artificial intelligence, summarizes the salient and important points from those notifications. Said differently, in one or more embodiments the notification summarization operation collects and summarizes notifications received by a communication device of the electronic device 100 while the first state meets the at least a first criterion and the second state meets the at least a second criterion.

In one or more embodiments, as indicated at step 102, this step 102 also assigns a prioritization weight to each notification of the notifications received by the communication device of the electronic device 100 while the first state meets the at least a first criterion and the second state meets the at least a second criterion. In one or more embodiments, the prioritization weight is a function of an importance of the each notification to the user interacting with the electronic device 100. In one or more embodiments, step 102 comprises summarizing, by the one or more processors of the electronic device 100, the notifications received by the communication device of the electronic device 100 while the first state meets the at least a first criterion and the second state meets the at least a second criterion to create a notification summary 106.

At step 103, the one or more processors of the electronic device 100 then present the notification summary 106 on a user interface of the electronic device. In one or more embodiments, the one or more processors of the electronic device 100 terminate the notification summarization operation at step 103 when the first state ceases to meet the at least a first criterion and/or the second state ceases to meet the at least a second criterion. Thus, if Chuck 907 finished his workout, in one or more embodiments the one or more processors of the electronic device 100 would terminate the notification summarization operation and present the notification summary 106 on the user interface of the electronic device, as shown at step 104. Similarly, if the electronic device 100 were a clamshell electronic device and a first device housing was pivoted relative to a second device housing about a hinge to an axially displaced open position, the one or more processors may terminate the notification summarization operation and present the notification summary 106. Other examples for notification summarization operation termination and notification summary presentation will be obvious to those of ordinary skill in the art having the benefit of this disclosure.

In one or more embodiments, the presentation of the notification summary 106 occurs at step 103 only when the first state meets at least a third criterion, and the second state meets at least a fourth criterion. Illustrating by example, in one or more embodiments the third criterion comprises the electronic device 100 being situated in an illuminated environment. In one or more embodiments, the fourth criterion comprises one or more of engagement in a rest activity or a user proximity with the electronic device 100 for at least a predefined duration. Thus, if Chuck 907 stopped exercising or took the electronic device 100 out of the sleeve to interact with it the one or more processors might present the notification summary 106 on the user interface of the electronic device 100. Other examples of the third criteria and/or fourth criteria that may trigger the cessation of the notification summarization operation and presentation of the notification summary 106 will be obvious to those of ordinary skill in the art having the benefit of this disclosure.

As shown at step 104, in this example the notification summary 106 comprises summarization of a variety of notifications. In one or more embodiments, an artificial intelligence module is used to review and summarize notifications received by the communication device. In this illustration, Chuck's supervisor, Amit, needs an update on the super-secret project by the end of the day. And, magically, since the notification summary 106 is presented immediately when the first state meets the third criteria and/or the second state meets the fourth criteria, Chuck 907 immediately sees the notification about the free chicken giveaway from Buster's.

Using the electronic device 100 and corresponding method steps of FIG. 1, when Chuck 907 is exercising and his multiple notifications were received, the notification summary 106 harnesses the power of artificial intelligence to tailor the notification experience specifically to Chuck's needs when he is ready to get “plugged in” again after an unplugged session. Since Chuck 907 is a power user of Buster's Chicken Stand 909, the artificial intelligence module operating with the electronic device 100 knows to surface the chicken giveaway as a prioritized notification. Similarly, since Chuck 907 has to keep his job to be able to afford all of this tasty chicken 908, the artificial intelligence prioritizes the notification from his boss as well.

Thus, at step 104, instead of bombarding Chuck 907 with a flood of notifications when he exits his unplugged session, the artificial intelligence summarization occurring in the notification summarization operation instead now generates a customized summary highlighting the most important and relevant updates just for Chuck 907. There is no more sifting through a sea of notifications. Instead, Chuck 907 just sees the content that truly matters.

So, while existing solutions for managing notifications on electronic devices include notification summaries, do-not-disturb modes, and wearable devices that provide limited notification access. Indeed, with all the notifications Chuck 907 receives in a two hour period even if an existing notification presentation system presented the notification from Buster's on the display, Chuck 907 would have so much to go through that he would still miss the notification about the chicken 908. Advantageously, this is why the notification summary 106 presented at step 104 includes not only the fact that chicken 908 was available, but that Amit needs a project status too. For this reason, in one or more embodiments the notification summary 106 comprises a summary of multiple notifications. In one or more embodiments, those are summaries of larger communications so that Chuck 907 is apprised of the important information via summarization, not just the fact that his screen was littered with notifications that were surfaced and needed to be sorted through.

Thus, while prior art solutions often fall short in dynamically adapting to the user's state and the state of the electronic device, and further may not effectively prioritize notifications based on the user's context or provide a streamlined way to catch up on missed notifications since they only consider a single state (either user or device), which can result in unnecessary interruptions or missed important communications, the method steps of FIG. 1 provide an improved approach to managing notifications by dynamically detecting both the user state 107 and the device state 108 to trigger a notification summarization operation.

Advantageously, this dual-state detection ensures that the notification summarization operation is only triggered when specific conditions are met, reducing unnecessary interruptions and ensuring that Chuck 907 receives a concise summary of notifications when the timing is most appropriate, e.g., when the first state meets the at least a third criterion and the second state meets the at least a fourth criterion. In one or more embodiments, the method steps collect and summarize notifications received by the electronic device 100 while one or more predefined states are occurring. Thereafter, the method steps present the summarized notifications in the notification summary 106 only when Chuck 907 is able to interact with the electronic device 100. Advantageously, this approach minimizes information overload and ensures that Chuck 907 can quickly catch up on important communications without being overwhelmed by a flood of individual notifications, as would be the case in the prior art method of FIG. 9.

As shown at step 105, Chuck 907 was able to stroll past Mac and Henry's Pub 912 to Buster's Chicken Stand 909 from some of that tasty chicken 908. Since he's been working out, he decides to have extra. Chuck 907 experiences a true moment of joy while eating chicken 908 from Buster's Chicken Stand 909. This happiness stems from the fact that Chuck 907, having just completed an intense workout session, is able to indulge in his favorite meal without the guilt of missing important notifications. Indeed, since Chuck 907 is busy eating chicken, with the electronic device 100 stowed in his pocket, the one or more processors again start the notification summarization operation. The electronic device 100, configured with the notification summarization operation, ensures that Chuck 907 remains informed about updates without being overwhelmed by a flood of individual notifications.

The notification summary 106 presented by the electronic device 100 includes prioritized and concise information, allowing Chuck 907 to quickly catch up on communications. This efficient management of notifications means that Chuck 907 can enjoy his meal at Buster's Chicken Stand 909 with peace of mind, knowing that he has not missed any significant alerts. The seamless integration of technology into his daily routine enhances his overall experience, making the moment of enjoying chicken 908 even more satisfying.

Thus, in one or more embodiments the method steps of FIG. 1 involve an automatic AI-based notification summarization system that operates based on the user and device state. The system detects specific user states, such as physical activities like walking or running, low ambient light conditions, and proximity to the device. The system also monitors device states, including bendable configurations, adaptive display modes, and enclosed conditions like being in a pocket. Upon detecting these states, the system initiates a notification summarization process.

When the device detects that the device is in a non-handheld mode, such as being worn on the wrist or placed in a pocket, the system begins collecting incoming notifications in one or more embodiments. The AI-based text summarization models then process these notifications, creating a prioritized and concise summary. This summary is tailored to the user's context, ensuring that only the relevant information is presented. The system continues to update the summary in real-time as new notifications arrive.

Once the user returns to a state where they can interact with the device, such as switching the device back to full mode or entering a well-lit area, the system presents the summarized notifications. This approach minimizes information overload and ensures that users can quickly catch up on important communications without being overwhelmed by a flood of individual notifications. The system's ability to dynamically adapt to both user and device states provides a seamless and efficient notification management experience.

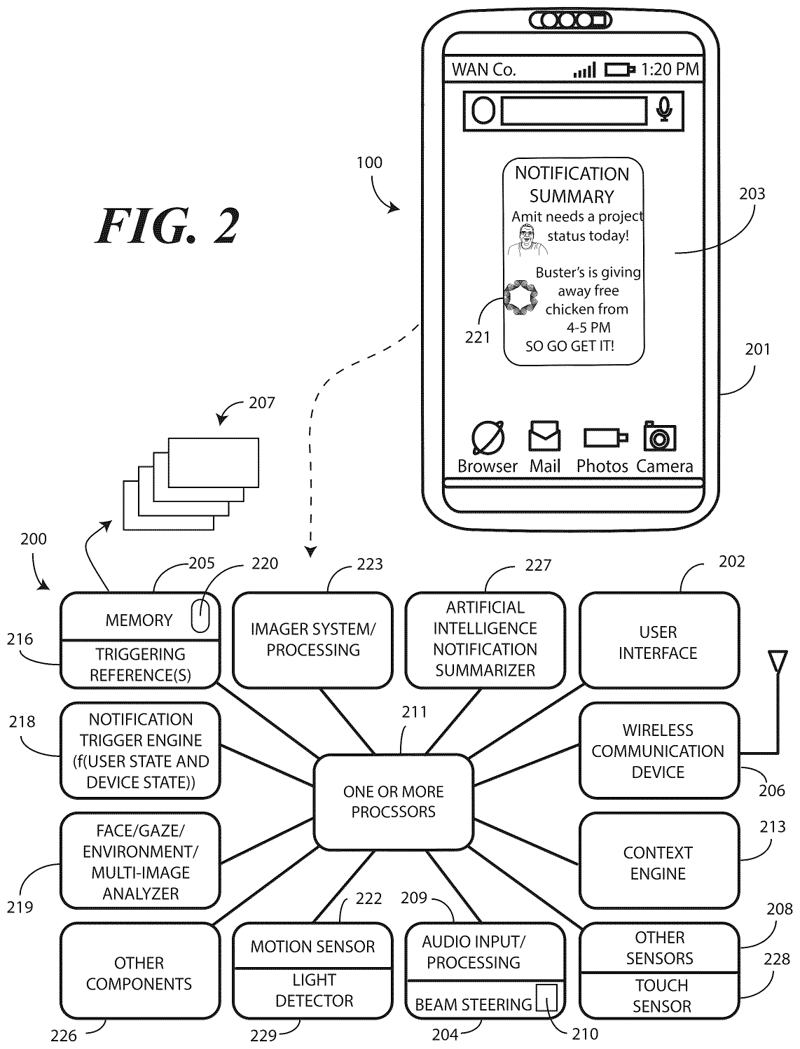

Turning now to FIG. 2, illustrated therein is one explanatory block diagram schematic 200 of the explanatory electronic device 100 of FIG. 1. In one or more embodiments, the block diagram schematic 200 is configured as a printed circuit board assembly disposed within a housing 201 of the electronic device 100. Various components can be electrically coupled together by conductors, or a bus disposed along one or more printed circuit boards.

The illustrative block diagram schematic 200 of FIG. 2 includes many different components. Embodiments of the disclosure contemplate that the number and arrangement of such components can change depending on the particular application. Accordingly, electronic devices configured in accordance with embodiments of the disclosure can include some components that are not shown in FIG. 2, and other components that are shown may not be needed and can therefore be omitted.

The illustrative block diagram schematic 200 includes a user interface 202. In one or more embodiments, the user interface 202 includes a display 203, which may optionally be touch-sensitive. In one embodiment, users can deliver user input to the display 203 of such an embodiment by delivering touch input from a finger, stylus, or other objects disposed proximately with the display 203. In one embodiment, the display 203 is configured as an active matrix organic light emitting diode (AMOLED) display. However, it should be noted that other types of displays, including liquid crystal displays, suitable for use with the user interface 202 would be obvious to those of ordinary skill in the art having the benefit of this disclosure.

As noted above, in one or more embodiments the electronic device 100 includes one or more processors 211. In one embodiment, the one or more processors 211 can include an application processor and, optionally, one or more auxiliary processors.

One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the block diagram schematic 200. Each of the application processor and the auxiliary processor(s) can be configured to process and execute executable software code to perform the various functions of the electronic device with which the block diagram schematic 200 operates. A storage device, such as memory 205, can optionally store the executable software code used by the one or more processors 211 during operation.

In this illustrative embodiment, the block diagram schematic 200 also includes a communication circuit 206 that can be configured for wired or wireless communication with one or more other devices or networks. The networks can include a wide area network, a local area network, and/or personal area network. The communication circuit 206 may also utilize wireless technology for communication, such as, but are not limited to, peer-to-peer or ad hoc communications such as HomeRF, Bluetooth and IEEE 802.11, and other forms of wireless communication such as infrared technology. The communication circuit 206 can include wireless communication circuitry, one of a receiver, a transmitter, or transceiver, and one or more antennas.

In one embodiment, the one or more processors 211 can be responsible for performing the primary functions of the electronic device with which the block diagram schematic 200 is operational. For example, in one embodiment the one or more processors 211 comprise one or more circuits operable with the user interface 202 to present presentation information to a user. The executable software code used by the one or more processors 211 can be configured as one or more modules 207 that are operable with the one or more processors 211. Such modules 207 can store instructions, control algorithms, and so forth.

In one or more embodiments, a notification trigger engine 218 is operable to detect, using one or more sensors 208 of the electronic device 100, a first state of the electronic device 100 and a second state of a user interacting with the electronic device 100. In one or more embodiments, the notification trigger engine 218 can determine whether the first state meets at least a first criterion and whether the second state meets at least a second criterion. Where these conditions are met, the notification trigger engine 218 triggers an artificial intelligence-based notification summarization operation performed by an artificial intelligence notification summarizer 227 within the electronic device 100. The artificial intelligence notification summarizer 227 can then collect the notification data 220 received by the communication device 206 of the electronic device 100 during the artificial intelligence-based notification summarization operation.

In one or more embodiments, the artificial intelligence notification summarizer 227 summarizes the collected notification data 220 to generate the summarized notifications 221, one example of which is presented on the display 201 of the electronic device 100. In one or more embodiments, the one or more processors 211 present the summarized notifications 221 on the user interface 202 of the electronic device 100 when the first state ceases to meet the at least a first criterion and/or the second state ceases to meet the at least a second criterion. As noted above, in one or more embodiments the first state comprises the electronic device 100 being transported in a wearable configuration and the second state comprises the user being engaged in physical activity. Other states will be obvious to those of ordinary skill in the art having the benefit of this disclosure.

Illustrating by example, in one or more embodiments the one or more processors 211, in response to the one or more sensors 208 detecting a predefined device state, collect notification data 220 and summarize the notification data 220 to generate summarized notifications 221 while the predefined device state is occurring. In one or more embodiments, the one or more processors 211 cause the user interface 202 to present the summarized notifications 221 when occurrence of the predefined device state ceases as detected by the one or more sensors 208.

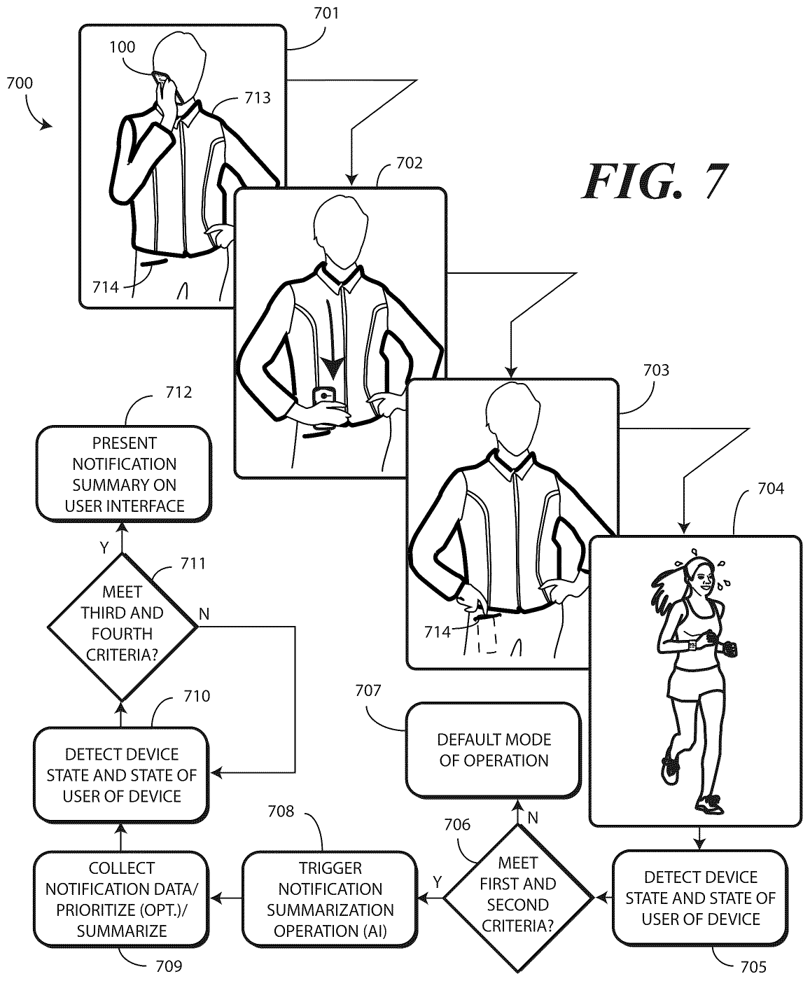

In one or more embodiments, as will be shown below with reference to FIG. 7, the predefined device state comprises the electronic device 100 being positioned in a pocket. In one or more embodiments, the predefined device state comprises the electronic device 100 moving in accordance with a walking motion or running motion. Accordingly, when the user places the electronic device 100 in their pocket and begins exercising by taking a walk, the one or more processors 211 of the electronic device 100 may initiate a series of operations to manage incoming notifications.

In one or more embodiments, the one or more sensors 208, including motion sensors 222 and light sensors 229, detect the predefined device state of being in a pocket and the user state of engaging in physical activity. The motion sensors 222 identify the walking motion, while the light sensors 229 confirm the low-light environment typically associated with being in a pocket.

Upon detecting these states, the one or more processors 211 begin collecting notification data 220 received by the communication circuit 206 of the electronic device 100. The processors 211 then, optionally employ AI-based text summarization models, process the collected notification data 220. Where used these models analyze the content of each notification, extracting information and generating summarized notifications 221. The summarization process can involve assigning prioritization weights to each notification based on the importance to the user, ensuring that the most relevant information is highlighted.

As the user continues walking, in one or more embodiments the one or more processors 211 continuously update the summarized notifications 221 in real-time, incorporating new incoming notifications into the summary. This dynamic updating ensures that the user receives a concise and prioritized digest of notifications. When the user stops walking and removes the electronic device 100 from their pocket, the one or more sensors 208 detect the change in state from signals received by the one or more sensors 208. The one or more processors 211 then present the summarized notifications 221 on the user interface 202, allowing the user to quickly review important communications without being overwhelmed by a flood of individual notifications.

In other embodiments, the predefined state can be the electronic device 100 being transformed to a wearable state. When the user transforms the electronic device 100 to a wearable state, such as attaching the electronic device 100 to an arm while working out, the one or more processors 211 of the electronic device 100 can initiate a series of operations to manage incoming notifications. The one or more sensors 208, including motion sensors 222, the light sensors 229, and eve the imager processor system 223, detect the predefined device state of being in a wearable configuration and the user state of engaging in physical activity. The motion sensors 222 identify the physical activity, such as walking or running, while the light sensors 229 or imager processor system 223 confirm the ambient light conditions typically associated with the wearable state.

Upon detecting these states, the one or more processors 211 begin collecting notification data 220 received by the communication circuit 206 of the electronic device 100. The processors 211 then employ AI-based text summarization models to process the collected notification data 220. These models analyze the content of each notification, extracting information and generating summarized notifications 221. The summarization process can involve assigning prioritization weights to each notification based on the importance to the user, ensuring that the most relevant information is highlighted.

As the user continues the physical activity, the one or more processors 211 continuously update the summarized notifications 221 in real-time, incorporating new incoming notifications into the summary. This dynamic updating ensures that the user receives a concise and prioritized digest of notifications. When the user stops the physical activity and removes the electronic device 100 from the wearable state, the one or more sensors 208 detect the change in state. The one or more processors 211 then present the summarized notifications 221 on the user interface 202, allowing the user to quickly review important communications without being overwhelmed by a flood of individual notifications.

In still other embodiments, the predefined device state comprises the electronic device 100 being positioned in a low-light environment. Illustrating by example, when a user goes to see a movie and the electronic device 100 is in a low-light environment, the one or more processors 211 of the electronic device 100 can also initiate the notification summarization operation. The one or more sensors 208, including light sensors 229, detect the low-light environment. Upon detecting this state, the one or more processors 211 begin collecting notification data 220 received by the communication circuit 206 of the electronic device 100. The processors 211 can then employ AI-based text summarization models to process the collected notification data 220. These models analyze the content of each notification, extracting information and generating summarized notifications 221.

In one or more embodiments, the one or more processors 211 further prioritize the notification data 220. In one or more embodiments, the one or more processors 211 do this by assigning a prioritization weight to each notification of the notification data 220. In one or more embodiments, the prioritization weight is a function of an importance of each notification to a user interacting with the user interface 202 of the electronic device 100.

Thus, in one or more embodiments the summarization process involves assigning prioritization weights to each notification based on the importance to the user, ensuring that the most relevant information is highlighted. Continuing the movie watching example, as the user continues to watch the movie, the one or more processors 211 cam continuously update the summarized notifications 221 in real-time, incorporating new incoming notifications into the summary. This dynamic updating ensures that the user receives a concise and prioritized digest of notifications.

In one or more embodiments, the one or more processors 211 further terminate the generation of the summarized notifications when the electronic device 100 exits the predefined device state. The one or more processors 211 can also present the summarized notifications 221 on the user interface 202 when the electronic device 100 enters another predefined device state that is different from the predefined device state. With the example of a movie, when the user exits the low-light environment, such as when the movie ends and the lights are turned on, the one or more sensors 208 detect the change in state. The one or more processors 211 then present the summarized notifications 221 on the user interface 202, allowing the user to quickly review important communications without being overwhelmed by a flood of individual notifications.

Turning now to the various sensors 208, in one or more embodiments the block diagram schematic 200 includes an audio input/processor 209. The audio input/processor 209 is operable to receive audio input from an environment about the electronic device 100. The audio input/processor 209 can include hardware, executable code, and speech monitor executable code in one embodiment.

In one or more embodiments, the audio input/processor 209 is operable with the one or more audio transducers to perform an “acoustic sweep” when the electronic device 100 to determine the device state (180). In one or more embodiments, this acoustic sweep can be used to determine the electronic device 100 is in an enclosed condition.

In one or more embodiments, the audio input/processor 209 performs an acoustic sweep by causing one or more loudspeakers of the one or more audio transducers to emit predefined acoustic signals. At the same time, the audio input/processor 209 causes one or more microphones 210 of the one or more audio transducers to receive the predefined acoustic signals emitted by the one or more loudspeakers of the one or more audio transducers.

The audio input/processor 209 can then measure attenuation or other transfer function degradation of those signals as received by one or more microphones of the one or more audio transducers of the electronic device 100. Accordingly, in one embodiment the acoustic sweep comprises delivering, from one or more audio output devices, a predefined acoustic output to one or more microphones 210 and measuring, with one or more processors 211, attenuation of the predefined acoustic output occurring between the one or more audio output devices and the one or more microphones. The response coefficients can then be used to determine the device state (108).

In addition to being used to determine the device state (108), the audio input/processor 209 can use the sweeps to determine in what type of repository container the electronic device 100 is situated as well when the electronic device 100 is enclosed. Using the example of a pocket as a repository container, in one or more embodiments the audio input/processor 209 can be operable with one or more predefined authentication references 216 stored in memory 205. With reference to audio input, the predefined authentication references 216 can comprise representations of audio signals received during audio sweeps in predefined conditions.

For example, one predefined authentication reference 216 can comprise a representation of an audio sweep when the electronic device 100 is disposed in free space. Another predefined authentication reference 216 can comprise a representation of an audio sweep when the electronic device 100 is disposed within a denim pocket. Another authentication reference 216 can comprise a representation of an audio sweep when the electronic device 100 is disposed within a nylon pocket. Still another authentication reference 216 can comprise a representation of an audio sweep when the electronic device 100 is disposed within a corduroy pocket. By comparing the results of a performed audio sweep with the authentication references 216 stored in memory 205, the one or more processors 211 can estimate an identification of the material of the pocket.

Where no sufficiently matching predefined authentication reference 216 is found in the table in memory 205 such as resulting from multiple layers of clothing, the audio input/processor 209 or the one or more processors 211 can create a new predefined authentication reference 216. Illustrating by example, the one or more processors 211 may present a prompt on the display 203 asking the user whether the electronic device 100 is situated within a pocket. If the user indicates in the affirmative, the one or more processors 211 may place another prompt on the display 203 asking the identity of the material. Accordingly, in one or more embodiments, upon failing to find a sufficiently matching predefined authentication reference 216 in the table in memory 205, the audio input/processor 209 or the one or more processors 211 may record the audio signal adjustment function from the audio sweep in the table as a new audio signal adjustment function or it may calculate the new signal adjustment function using other more direct methods detailed below.

The audio input/processor 209 can include a beam steering engine 204 comprising one or more microphones 210. Input from the one or more microphones 210 can be processed in the beam steering engine 204 such that the one or more microphones define a virtual microphone. This virtual microphone can define an acoustic reception cone that can be virtually “steered” around the electronic device 100. Alternatively, actual steering can occur as well, such as switching between a left and right microphone or a front and back microphone or switching various microphones ON and OFF individually. In one or more embodiments, two or more microphones 210 can be included for selective beam steering by the beam steering engine 204.

Illustrating by example, a first microphone can be located on a first side of the electronic device 100 for receiving audio input from a first direction, while a second microphone can be placed on a second side of the electronic device 100 for receiving audio input from a second direction. These microphones can be “steered”by selectively turning them ON and OFF.

The beam steering engine 204 can then select between the first microphone and the second microphone to beam steer audio reception toward an object, such as a user delivering audio input. Illustrating by example, different microphones can be selected based upon their location along the electronic device 100 relative to acoustic energy generating source locations. The separation between microphones can be included as factors in beam steering, as well as the resulting phase shifts the incoming acoustic energy occurs as detected by microphones in different locations. In other words, since the microphones are disposed at different locations along the electronic device 100, each microphone responds respond differently to received acoustic energy based upon its separation and the location of the source of the acoustic energy. This beam steering can be responsive to input from other sensors, such as imagers, facial depth scanners, thermal sensors, or other sensors. For example, an imager can estimate a location of a person's face and deliver signals to the beam steering engine 204, thereby alerting it in which direction to focus the acoustic reception cone and/or steer the first microphone and the second microphone.

Alternatively, the beam steering engine 204 processes and combines the signals from two or more microphones to perform beam steering. The one or more microphones 210 can be used for voice commands. In response to control of the one or more microphones 210 by the beam steering engine 204, a user location direction can be determined. The beam steering engine 204 can then select between the first microphone and the second microphone to beam steer audio reception toward the user. Alternatively, the audio input/processor 209 can employ a weighted combination of the microphones to beam steer audio reception toward the user. In either of these embodiments, each microphone can be an omnidirectional microphone element or a directional microphone element.

In one or more embodiments, many of these other sensors 208 are environmental sensors to detect environmental conditions about the electronic device 100. General examples of these sensors include time sensors, date sensors, environmental sensors, weather sensors, ultrasonic sensors, location sensors, and so forth.

In one embodiment, a skin sensor is configured to determine when the electronic device 100 is touching the skin of a person. For example, when the electronic device 100 is being held within the hand of a user, this can be detected by the skin sensor, which can be disposed along an edge of the electronic device 100 in one or more embodiments. The skin sensor can include a substrate with an electrode disposed thereon. The electrode can confirm the object touching the skin sensor is skin by detecting electrical signals generated by a heartbeat in one embodiment. Other forms of skin sensors will be obvious to those of ordinary skill in the art having the benefit of this disclosure.

A touch sensor can be operable with, or in place of, the skin sensor. The touch sensor can include a capacitive touch sensor, an infrared touch sensor, resistive touch sensors, or another touch-sensitive technology. In one or more embodiments, the touch sensor comprises a plurality of touch sensors. For example, a first touch senso can be disposed on the front major face of the electronic device 100. A second touch sensor can be disposed on the rear major face of the electronic device 100. A third touch sensor can be situated along one or more of the minor faces defined by the sides of the electronic device 100. Capacitive touch-sensitive devices include a plurality of capacitive sensors, e.g., electrodes, which are disposed along a substrate. Each capacitive sensor is configured, in conjunction with associated control circuitry, e.g., the one or more processors 211, to detect an object in close proximity with - or touching - the surface of the display 203 or the housing 201 of the electronic device 100 by establishing electric field lines between pairs of capacitive sensors and then detecting perturbations of those field lines.

A force sensor can be included. The force sensor can take various forms. For example, in one embodiment, the force sensor comprises resistive switches or a force switch array configured to detect contact with either the display 203 or the housing 201 of the electronic device 100. An “array” refers to a set of at least one switch. The array of resistive switches can function as a force-sensing layer, in that when contact is made with either the surface of the display 203 or the housing 201 or the touch sensors 302 of the electronic device 100, changes in impedance of any of the switches may be detected. A temperature sensor can be configured to monitor the temperature of the environment.

In one or more embodiments, the one or more processors 106 may require location information of the electronic device 100, such as to know whether the electronic device 100 is in a car. Accordingly, in one embodiment a global positioning system device can be included for determining a location and/or movement of the electronic device 100. In one or more embodiments, the global positioning system device is configured for communicating with a constellation of earth orbiting satellites or a network of terrestrial base stations to determine an approximate location. The satellite positioning systems based location fixes of the global positioning system device autonomously or with assistance from terrestrial base stations, for example those associated with a cellular communication network or other ground based network, or as part of a Differential Global Positioning System (DGPS), as is well known by those having ordinary skill in the art.

While a global positioning system device is one example of a location determination device, it will be clear to those of ordinary skill in the art having the benefit of this disclosure that other location determination devices, such as electronic compasses or gyroscopes, could be used as well. For example, the global positioning system device can be replaced by, or accompanied by, a location detector able to determine location by locating or triangulating terrestrial base stations of a traditional cellular network, such as a CDMA network or GSM network, or from other local area networks, such as Wi-Fi networks.

A proximity detector component can emit infrared signals to determine when the electronic device 100 is covered by an object such as the sides of a repository container or the items disposed therein. Other sensors, subsets of these sensors, and so forth can be used in accordance with the methods described herein.

The other sensors 208 can also include a motion sensor 222. The motion sensor 22 can include motion detectors, such as one or more accelerometers or gyroscopes. For example, an accelerometer may be embedded in the electronic circuitry of the electronic device 100 to show vertical orientation, constant tilt and/or whether the electronic device 100 is stationary. The measurement of tilt relative to gravity is referred to as “static acceleration,” while the measurement of motion and/or vibration is referred to as “dynamic acceleration.” A gyroscope can be used in a similar fashion.

Regardless of the type of motion sensors 222 that are used, in one embodiment the motion sensors 22 are also operable to detect movement, and direction of movement, of the electronic device 100 by a user. In one or more embodiments, the other sensors 208 and the motion sensors 222 can each be used to detect motion corresponding to a user's body or to human motion. This information can be used to determine that the electronic device 100 is proximately located with a user's body.

Illustrating by example, in one embodiment when the electronic device 100 is placed within a pocket 115 of clothing that a user is wearing, the motion sensors 222 can be used to detect predefined motions corresponding to human motion. These predefined motions can be small, and can include vibration, shaking, breathing, micromotions, and so forth.

For instance, if the user is walking, the motion sensors 222 can detect this movement. The one or more processors 211 can then extract parametric data from electronic signals delivered by these motion sensors 222 in response to the user walking. By comparing the parametric data to a reference file stored in memory 205, the one or more processors 211 can identify the walking motion as corresponding to the motion of the user's body. The one or more processors 211 can use this information to distinguish the electronic device 100 being in a user's pocket 115 compared to, for example, being in a drawer.

Similarly, if the user is simply sitting in a chair, the motion sensors 222 can be used to detect body motions—even tiny ones—such as that of the user breathing. By comparing the parametric data extracted from this motion to a reference file stored in memory 205, the one or more processors 211 can identify the fact that the movement that the electronic device 100 is experiencing is due to the fact that the electronic device 100 is proximately located with a user's torso, limbs, head, or appendages, or otherwise generally disposed along the user body instead of, for example, being placed on a table. Other user motion that can be readily detected by parametric data includes motion associated with driving, riding a bike, or simply shifting in their seat. In one or more embodiments, the one or more processors 211 can conclude from these motions that the electronic device 100 is disposed near or on a person's body.

The motion sensors 222 can be configured as an orientation detector that determines an orientation and/or movement of the electronic device 100 in three-dimensional space. The orientation detector can determine the spatial orientation of an electronic device 100 in three-dimensional space by, for example, detecting a gravitational direction. In addition to, or instead of, an accelerometer, an electronic compass can be included to detect the spatial orientation of the electronic device 100 relative to the earth's magnetic field. Similarly, one or more gyroscopes can be included to detect rotational orientation of the electronic device 100.

In one or more embodiments an authentication system is operable with the one or more processors 211 to detect the identity of an authorized user of the electronic device 100. A first authenticator of the authentication system can include an imager processing system 223. The imager processing system 223 can include one or more of an imager, a depth imager, thermal sensor, or combinations thereof. In one embodiment, the imager comprises a two-dimensional imager configured to receive at least one image of a person within an environment of the electronic device 100. In one embodiment, the imager comprises a two-dimensional Red-Green-Blue (RGB) imager. In another embodiment, the imager comprises an infrared imager. Other types of imagers suitable for use with the imager processing system 223 and the authentication system will be obvious to those of ordinary skill in the art having the benefit of this disclosure.

Where included, the thermal sensor of the imager processing system 223 can also take various forms. In one embodiment, the thermal sensor is simply a proximity sensor component, also referred to as “presence sensor,” which detects temperature change. In another embodiment, the thermal sensor comprises a simple thermopile. In another embodiment, the thermal sensor comprises an infrared imager that captures the amount of thermal energy emitted by an object. Other types of thermal sensors will be obvious to those of ordinary skill in the art having the benefit of this disclosure.

Where included, the depth imager can take a variety of forms. In a first embodiment, the depth imager comprises a pair of imagers separated by a predetermined distance, such as three to four images. This “stereo” imager works in the same way the human eyes do in that it captures images from two different angles and reconciles the two to determine distance.

In another embodiment, the depth imager employs a structured light laser. The structured light laser projects tiny light patterns that expand with distance. These patterns land on a surface, such as a user's face, and are then captured by an imager. By determining the location and spacing between the elements of the pattern, three-dimensional mapping can be obtained.

In still another embodiment, the depth imager comprises a time of flight device. Time of flight three-dimensional sensors emit laser or infrared pulses from a photodiode array. These pulses reflect back from a surface, such as the user's face. The time it takes for pulses to move from the photodiode array to the surface and back determines distance, from which a three-dimensional mapping of a surface can be obtained. Regardless of embodiment, the depth imager adds a third “z-dimension” to the x-dimension and y-dimension defining the two-dimensional image captured by the imager, thereby enhancing the security of using a person's face as their password in the process of authentication by facial recognition.

The authentication system can be operable with a face/environmental analyzer 219. The face/environmental analyzer 219 can be configured to process an image or depth scan of an object and determine whether the object matches predetermined criteria by comparing the image or depth scan to one or more predefined authentication references stored in memory 205.

For example, the face/environmental analyzer 219 can operate as an authentication module configured with optical and/or spatial recognition to identify objects using image recognition, character recognition, visual recognition, facial recognition, color recognition, shape recognition, and the like. Advantageously, face/environmental analyzer 219, operating in tandem with the authentication system, can be used as a facial recognition device to determine the identity of one or more persons detected about the electronic device 100.

In one embodiment when the authentication system detects a person, one or both of the imager and/or the depth imager can capture a photograph and/or depth scan of that person. The authentication system can then compare the image and/or depth scan to one or more predefined authentication references stored in the memory 205. This comparison, in one or more embodiments, is used to confirm beyond a threshold authenticity probability that the person's face—both in the image and the depth scan—sufficiently matches one or more of the predefined authentication references stored in the memory 205 to authenticate a person as an authorized user of the electronic device 100.

The face/environmental analyzer 219 can include a gaze detector. The gaze detector can comprise sensors for detecting the user's gaze point. The gaze detector can optionally include sensors for detecting the alignment of a user's head in three-dimensional space. Electronic signals can then be processed for computing the direction of user's gaze in three-dimensional space. The gaze detector can further be configured to detect a gaze cone corresponding to the detected gaze direction, which is a field of view within which the user may easily see without diverting their eyes or head from the detected gaze direction. The gaze detector can be configured to alternately estimate gaze direction by inputting images representing a photograph of a selected area near or around the eyes. It will be clear to those of ordinary skill in the art having the benefit of this disclosure that these techniques are explanatory only, as other modes of detecting gaze direction can be substituted in the gaze detector of FIG. 2.

The face/environmental analyzer 219 can include its own image/gaze detection-processing engine as well. The image/gaze detection-processing engine can process information to detect a user's gaze point. The image/gaze detection-processing engine can optionally also work with the depth scans to detect an alignment of a user's head in three-dimensional space. Electronic signals can then be delivered from the imager or the depth imager for computing the direction of user's gaze in three-dimensional space. The image/gaze detection-processing engine can further be configured to detect a gaze cone corresponding to the detected gaze direction, which is a field of view within which the user may easily see without diverting their eyes or head from the detected gaze direction. The image/gaze detection-processing engine can be configured to alternately estimate gaze direction by inputting images representing a photograph of a selected area near or around the eyes. It can also be valuable to determine if the user wants to be authenticated by looking directly at device. The image/gaze detection-processing engine can determine not only a gazing cone but also if an eye is looking in a particular direction to confirm user intent to be authenticated.

Other components 226 operable with the one or more processors 211 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 226 can also include proximity sensors. The proximity sensors fall into one of two camps: active proximity sensors and “passive” proximity sensors. Either the proximity detector components or the proximity sensor components can be generally used for gesture control and other user interface protocols, some examples of which will be described in more detail below.

As used herein, a “proximity sensor component” comprises a signal receiver only that does not include a corresponding transmitter to emit signals for reflection off an object to the signal receiver. A signal receiver only can be used due to the fact that a user's body or other heat generating object external to device, such as a wearable electronic device worn by user, serves as the transmitter. An active proximity sensor, which includes a transmitter and a receiver, measures reflection of transmitted signals as received by a receiver. Passive proximity sensors include only a receiver that receives transmitted signals from outside the electronic device 100, e.g., body heat, etc. Illustrating by example, in one the proximity sensor components comprise a signal receiver to receive signals from objects external to the housing 201 of the electronic device 100. In one embodiment, the signal receiver is an infrared signal receiver to receive an infrared emission from an object such as a human being when the human is proximately located with the electronic device 100. In one or more embodiments, the proximity sensor component is configured to receive infrared wavelengths of about four to about ten micrometers. This wavelength range is advantageous in one or more embodiments in that it corresponds to the wavelength of heat emitted by the body of a human being.

Additionally, detection of wavelengths in this range is possible from farther distances than, for example, would be the detection of reflected signals from the transmitter of a proximity detector component. In one embodiment, the proximity sensor components have a relatively long detection range so as to detect heat emanating from a person's body when that person is within a predefined thermal reception radius. For example, the proximity sensor component may be able to detect a person's body heat from a distance of about fifteen feet in one or more embodiments. The ten-foot dimension can be extended as a function of designed optics, sensor active area, gain, lensing gain, and so forth.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level. Simulations show that a group of infrared signal receivers can operate with a total current drain of just a few microamps.

In one embodiment, the signal receiver of each proximity sensor component can operate at various sensitivity levels so as to cause the at least one proximity sensor component to be operable to receive the infrared emissions from different distances. For example, the one or more processors 211 can cause each proximity sensor component to operate at a first “effective” sensitivity so as to receive infrared emissions from a first distance. Similarly, the one or more processors 211 can cause each proximity sensor component to operate at a second sensitivity, which is less than the first sensitivity, so as to receive infrared emissions from a second distance, which is less than the first distance. The sensitivity change can be effected by causing the one or more processors 211 to interpret readings from the proximity sensor component differently.

By contrast, proximity detector components include a signal emitter and a corresponding signal receiver, which constitute an “active IR” pair. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers. The infrared transmitters are configured, in one embodiment, to transmit infrared signals having wavelengths of about 860 nanometers, which is one to two orders of magnitude shorter than the wavelengths received by the proximity sensor components. The proximity detector components can have signal receivers that receive similar wavelengths, i.e., about 860 nanometers.

In one or more embodiments, each proximity detector component can be an infrared proximity sensor set that uses a signal emitter that transmits a beam of infrared light that reflects from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

The other components 226 can optionally include a barometer operable to sense changes in air pressure due to elevation changes or differing pressures of the electronic device 100. Where included, in one embodiment the barometer includes a cantilevered mechanism made from a piezoelectric material and disposed within a chamber. The cantilevered mechanism functions as a pressure sensitive valve, bending as the pressure differential between the chamber and the environment changes. Deflection of the cantilever ceases when the pressure differential between the chamber and the environment is zero. As the cantilevered material is piezoelectric, deflection of the material can be measured with an electrical current.

The other components 226 can also optionally include a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 100. Similarly, a temperature sensor can be configured to monitor temperature about an electronic device.

A context engine 213 can then operate with the various sensors to detect, infer, capture, and otherwise determine persons and actions that are occurring in an environment about the electronic device 100. For example, where included one embodiment of the context engine 213 determines assessed contexts and frameworks using adjustable algorithms of context assessment employing information, data, and events. These assessments may be learned through repetitive data analysis. Alternatively, a user may employ the user interface 202 to enter various parameters, constructs, rules, and/or paradigms that instruct or otherwise guide the context engine 213 in detecting multi-modal social cues, emotional states, moods, and other contextual information. The context engine 213 can comprise an artificial neural network or other similar technology in one or more embodiments.

In one or more embodiments, the context engine 213, notification trigger engine 218, and artificial intelligence notification summarizer 227 are each operable with the one or more processors 211. In some embodiments, the one or more processors 211 can control the context engine 213, notification trigger engine 218, and artificial intelligence notification summarizer 227. In other embodiments, the context engine 213, notification trigger engine 218, and artificial intelligence notification summarizer 227 can operate independently, delivering information gleaned from detecting multi-modal social cues, emotional states, moods, and other contextual information to the one or more processors 211. The context engine 213, notification trigger engine 218, and artificial intelligence notification summarizer 227 can receive data from the various sensors. In one or more embodiments, the one or more processors 211 are configured to perform the operations of the context engine 213, notification trigger engine 218, and artificial intelligence notification summarizer 227.

It is to be understood that FIG. 2 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure.

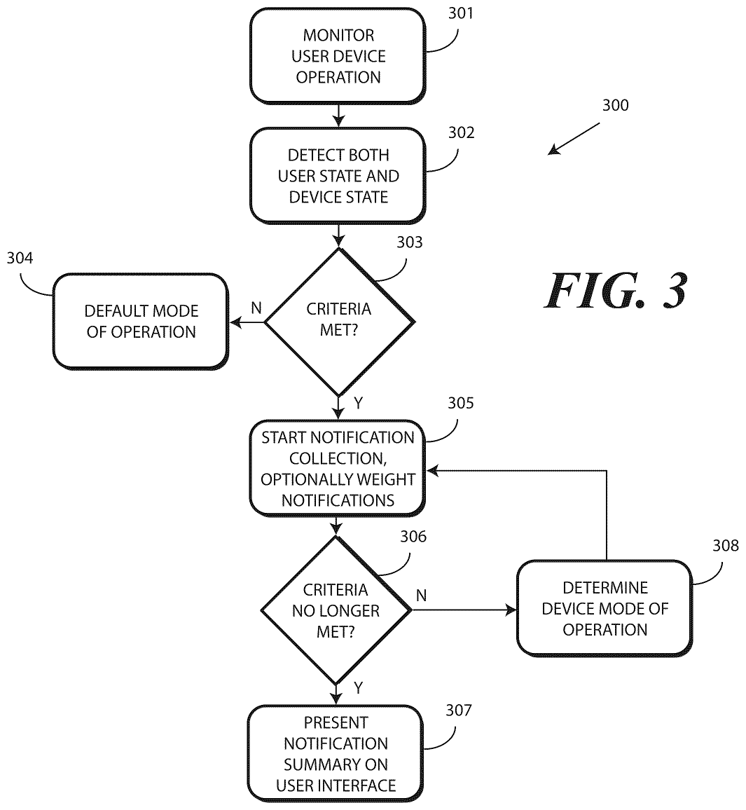

Turning now to FIG. 3, illustrates therein is one explanatory method 300 in accordance with one or more embodiments of the disclosure. The method 300 involves several steps and decisions that facilitate the automatic AI-based notification summarization based on user and device state.

At step 301, the method 300 monitors user device operation. Illustrating by example, in one or more embodiments step 301 can involve the electronic device receiving data from light sensors and accelerometer sensors. The light sensors detect the ambient light levels in the environment surrounding the device, while the accelerometer sensors measure the device's movement and orientation. These sensors can provide input data that the system uses to determine the current state of the device and the user at step 302. Illustrating by example, the light sensor data can help in identifying low-light conditions, and the accelerometer data can assist in detecting physical activities such as walking or running.

At step 302, the method 300 detects, using one or more sensors of the electronic device, a first state of the electronic device and a second state of the user interacting with the electronic device. Illustrating by example, in an embodiment step 302 can process data received from the light and accelerometer sensors to estimate the user's speed and the ambient light level. In one or more embodiments, the accelerometer data can be analyzed to determine the user's movement speed, which can indicate activities like walking or running. Simultaneously, the light sensor data is evaluated to assess the level of darkness in the user's environment. This estimation is necessary for determining whether the conditions meet the predefined criteria for triggering the notification summarization operation at decision 303.

In one or more embodiments, decision 3030 determines whether the first state meets at least a first criterion and the second state meets at least a second criterion. In one or more embodiments, the at least a first criterion comprises one or more of a first device housing of the electronic device being pivoted relative to a second device housing to a closed position, a display of the electronic device being placed in an adaptive display mode of operation, the electronic device being placed in a low-ambient light environment, the electronic device being in an enclosed condition, and/or the display of the electronic device being occluded by an object situated proximately with the display of the electronic device. In one or more embodiments, the at least a second criterion comprises one or more of engagement in a physical activity or a lack of proximity with the electronic device for at least a predefined duration.

In an illustrative embodiment, decision 303 can evaluate whether the estimated user speed exceeds a predefined threshold and whether the ambient light level is below a threshold. If both conditions are met, in one or more embodiments the system indicates that the user is engaged in a physical activity in a low-light environment, which may warrant the activation of the notification summarization feature at step 305. If either condition is not met, the system proceeds to continue with the device's default mode at step 304.

In one or more embodiments, step 305 comprises collecting and summarizing notifications received by a communication device of the electronic device while the first state meets the at least a first criterion and the second state meets the at least a second criterion. In one or more embodiments, step 305 further assigns a prioritization weight to each notification of the notifications received by the communication device of the electronic device while the first state meets the at least a first criterion and the second state meets the at least a second criterion. As noted above, in one or more embodiments the prioritization weight is a function of the importance of each notification to the user interacting with the electronic device.

In an illustrative embodiment, at step 305 the system begins collecting notification data received by the device during the period when the user is engaged in the identified activity. This step involves logging all incoming notifications to create a history that will be used for summarization. The collected data includes the content of the notifications, timestamps, and any other relevant metadata. In one or more embodiments, step 305 comprises summarizing, by the one or more processors, the notifications received by the communication device of the electronic device while the first state meets the at least a first criterion and the second state meets the at least a second criterion to create a notification summary.

In an illustrative embodiment, at step 305 the system assigns a prioritization weight to each collected notification. The weight is determined based on various factors, such as the importance of the notification to the user, the source of the notification, and the user's past interactions with similar notifications. This weighting process helps in creating a prioritized list of notifications, ensuring that the most relevant and important notifications are highlighted in the summary.

In one or more embodiments, step 305 involves the system using AI-based text summarization models to process the collected notification data. The models analyze the content of each notification, extract the most relevant information, and generate a concise summary. The notifications are then organized in an orderly manner based on their assigned weights, ensuring that the most important notifications are presented first. This step ensures that the user receives a clear and prioritized summary of all missed notifications.

In one or more embodiments. decision 306 involves checking whether the first state ceases to meet the at least a first criterion and/or the second state ceases to meet the at least a second criterion. Illustrating by example, in an embodiment decision 306 can check to see whether the user has moved to a well-lit area and remained there for a predefined threshold amount of time. In one or more embodiments, this decision 306 is based on continuous monitoring of the light sensor data. If the user is detected to be in a well-lit area for the required duration, the detection indicates that the user is now in a better position to view the notifications, and the system can proceed to present the summarized notifications at step 307. If the user is not in a well-lit area, the system continues to monitor the conditions at step 308.

In one or more embodiments, step 307 comprises presenting a notification summary on a user interface of the electronic device. In one or more embodiments, step 307 presents the summarized notifications in a format that is easy to read and understand, allowing the user to quickly catch up on important communications without being overwhelmed by a flood of individual notifications. This step 300 marks the completion of the notification summarization process, providing the user with a streamlined and efficient way to manage missed notifications.

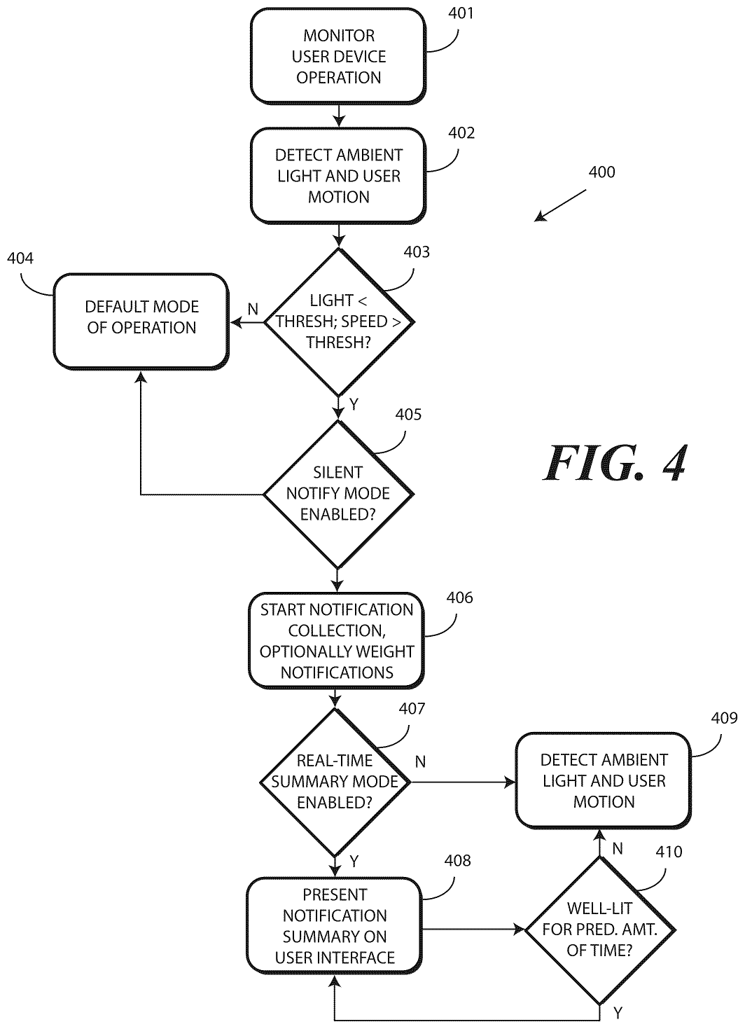

Turning now to FIG. 4, illustrated therein is another explanatory method 400 in accordance with one or more embodiments of the disclosure. The method 400 involves several steps and decisions that facilitate the automatic AI-based notification summarization based on user and device state.

Step 401 involves receiving data the various sensors of the electronic device to monitor user device information. Illustrating by example, step 402 can receive data from light sensors and accelerometer sensors. Where these are the sensors used, the light sensors detect the ambient light levels in the environment surrounding the device, while the accelerometer sensors measure the device's movement and orientation. These sensors provide input data that the system uses to determine the current state of the device and the user.

In one or more embodiments, step 402 involves estimating the user's speed and the ambient light level. The accelerometer data is analyzed to determine the user's movement speed, which can indicate activities like walking or running. Simultaneously, the light sensor data is evaluated to assess the level of darkness in the user's environment. This estimation is necessary for determining whether the conditions meet the predefined criteria for triggering the notification summarization operation.

Decision 403 determines whether the user's speed is above a predefined threshold and whether the ambient light level is below a threshold. If both conditions are met, the system indicates that the user is engaged in a physical activity in a low-light environment, which may warrant the activation of the notification summarization feature at step 406.

If either condition is not met, the system proceeds to continue with the device's default mode at step 404. In one or more embodiments, step 404 involves continuing with the device's default mode if the conditions for triggering the notification summarization operation are not met. This step ensures that the device operates normally without initiating the summarization process.

Decision 405 checks whether the a silent notification feature is enabled. If the feature is enabled, the system proceeds to step 406. If the feature is not enabled, the system continues with the device's default mode at step 404.

In one or more embodiments, step 406 involves starting the notification history collection. The system begins collecting notification data received by the device during the period when the user is engaged in the identified activity. This step 406 can involve logging all incoming notifications to create a history that will be used for summarization. The collected data includes the content of the notifications, timestamps, and any other relevant metadata.

Decision 407 determines whether a the AI summary feature is enabled. If the AI summary feature is enabled and a real-time summary is required, the system proceeds to step 408. If a real-time summary is not required, the system continues to monitor the conditions and update the notification history at step 409.

Step 408 involves summarizing the notifications in an orderly manner. In one or more embodiments, the system uses AI-based text summarization models to process the collected notification data. The models analyze the content of each notification, extract the most relevant information, and generate a concise summary. The notifications are then organized based on their assigned weights, ensuring that the most important notifications are presented first.

Step 408 also involves presenting the summarized notifications. The system presents the summarized notifications in a format that is easy to read and understand, allowing the user to quickly catch up on important communications without being overwhelmed by a flood of individual notifications.

Decision 410 checks whether the user is in a well-lit area for a threshold amount of time. If the user is detected to be in a well-lit area for the required duration, the system proceeds to present the summarized notifications at step 408. If the user is not in a well-lit area, the system continues to monitor the conditions and update the notification history at step 409.

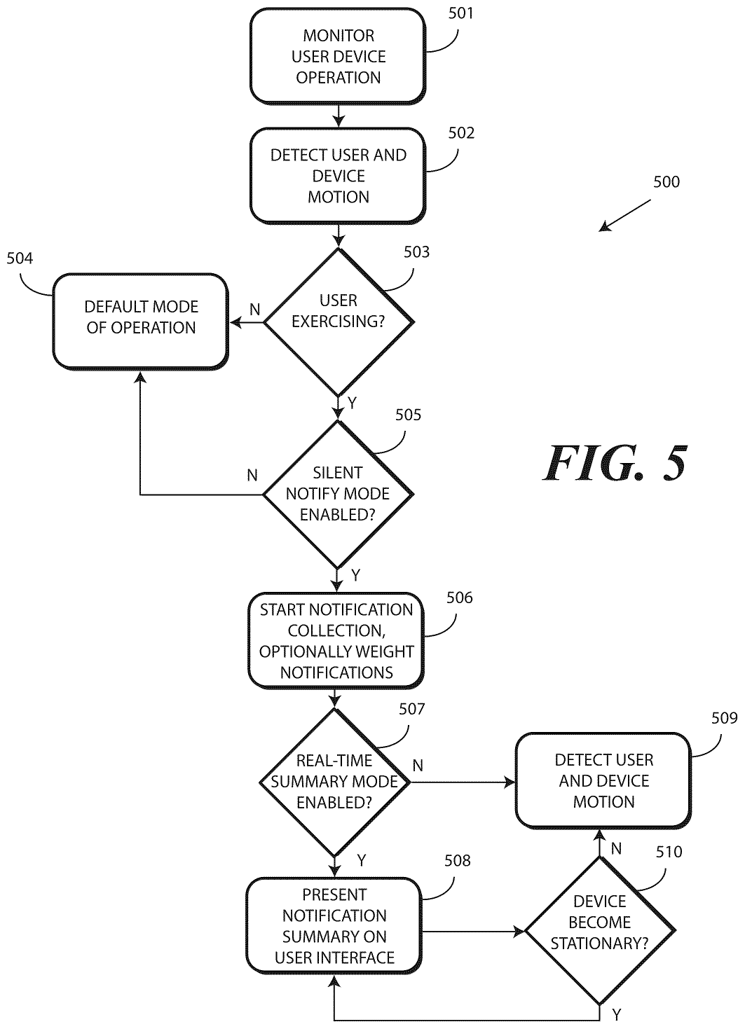

Turning now to FIG. 5, illustrated therein is another explanatory method 50 in accordance with one or more embodiments of the disclosure. As described above, embodiments of the electronic device can detect a first state of the electronic device and a second state of a user interacting with the electronic device. Illustrating by example, the imager processing system (223) can capture images of the user and can use image processing techniques to determine what the user is doing or how the user is interacting with the electronic device.

As also noted above, the at least a second criterion to which the state of the user is compared can vary. Embodiments of the disclosure contemplate that the notification summarization operation described herein can be useful when a user is doing a lot of things, examples of which include sleeping, going on a date, watching television, attending a meeting, reading a book, attending a sports event, watching a movie, voting, driving, undergoing surgery, cooking, or performing other activities.

Indeed, users may engage in a wide variety of various activities where the notification summarization operation presenting a notification summary proves beneficial. For instance, during physical activities such as running or walking, users often find checking their devices challenging. The summarization operation ensures that users receive a concise summary of important notifications once the activity concludes, allowing them to stay informed without interrupting their exercise routine. Similarly, when driving, users focus on the road, making checking notifications unsafe. The summarization operation collects and prioritizes notifications, presenting them when the user is no longer driving, thereby enhancing safety and ensuring important messages are not missed.

Another scenario involves users attending meetings or conferences where checking devices may be inappropriate or distracting. The summarization operation gathers notifications during the meeting and presents a summary afterward, enabling users to catch up on important communications without disrupting the meeting. Additionally, users watching movies or attending events in low-light environments benefit from the summarization operation, as the summarization operation collects notifications and presents a summary when the user is in a better-lit area, reducing eye strain and ensuring they do not miss updates.

Users may also find the summarization operation advantageous when their devices are in non-handheld modes, such as being placed in a pocket or worn on the wrist. In these situations, the device's display may be inaccessible, and the summarization operation ensures that notifications are collected and summarized for later review. This feature is particularly useful for users engaged in activities like cooking, where hands-free operation is necessary. By presenting a notification summary when the device is accessible, users can efficiently manage their notifications without compromising their ongoing tasks. Still other examples of activities where the notification summarization operation will be beneficial will be obvious to those of ordinary skill in the art having the benefit of this disclosure. The method 500 of FIG. 5 is particularly directed to the activity of exercising, although it will be obvious to those of ordinary skill in the art having the benefit of this disclosure that any of the other activities listed here, or others that will be obvious to those of ordinary skill in the art having the benefit of this disclosure, can be substituted for the exercising operation.

FIG. 5 illustrates a method 500 for triggering a notification summarization operation based on user and device state. The method 500 involves several steps and decisions that facilitate the automatic AI-based notification summarization.

In one or more embodiments, step 501 comprises monitoring user device operation. In one or more embodiments, step 501 comprises receiving data from various sensors of the electronic device to monitor user device information. The sensors can include light sensors, accelerometer sensors, gyroscope sensors, and location sensors. The light sensors can detect the ambient light levels in the environment surrounding the device, while the accelerometer sensors can measure the device's movement and orientation. The gyroscope sensors provide additional data on the device's rotational movement, and the location sensors determine the device's geographical position. An image capture device can capture images for processing that depict a user engaged in an activity or interacting with the electronic device. In one or more embodiments, these sensors provide input data that the system uses to determine the current state of the device and the user.

Step 502 involves estimating both the motion of the electronic device and the motion of the user. Embodiments of the disclosure contemplate that the detection of motion of the electronic device and the user, and a comparison of the two, can be used not only to tell if the user is exercising at decision 503, but whether the user has the electronic device in their possession while exercising. Illustrating by example, if the user is moving with a walking motion and the electronic device is swinging with the same rhythm, it is likely the user is walking with the electronic device. By contrast, if the user is doing a set of burpees and the electronic device is still, it is likely the electronic device is sitting on a table or other stationary object, and so forth.

In one or more embodiments, at step 502 of FIG. 5 the sensors of the electronic device detect motion of the electronic device and motion of the user to determine whether the user is exercising. The motion sensors, including accelerometers and gyroscopes, can be operable to measure the device's movement and orientation. The accelerometers may detect linear acceleration along multiple axes, while the gyroscopes may measure angular velocity. By analyzing the data from these sensors at decision 503, the system can identify patterns indicative of specific physical activities.

For instance, the accelerometers might capture the rhythmic motion associated with walking or running, characterized by periodic peaks and troughs in the acceleration data. The gyroscopes might then provide complementary information by detecting the rotational movements of the device, which can further confirm the type of physical activity. Step 502 processes this sensor data to estimate the user's speed and movement patterns, comparing them against predefined thresholds to determine if the user is engaged in exercise at decision 503.

Additionally, step 502 may utilize machine learning algorithms trained on a dataset of motion patterns corresponding to various physical activities. These algorithms analyze the real-time sensor data to classify the user's activity with high accuracy. By combining the outputs from the accelerometers, gyroscopes, and machine learning models, in one or more embodiments decision 503 can reliably detect when the user is exercising, thereby triggering the appropriate notification summarization operation.

Decision 503 determines whether the user is engaged in exercise. Using the illustrative method 500 of FIG. 5, if the user is engaged in exercise the method 500 proceeds to decision 505. By contrast, if the user is not exercising, a default mode of operation where no notification summarization operation is actuated continues at step 504.

Decision 505 of FIG. 5 detects whether a user of the electronic device has enabled, using user settings of the electronic device, the presentation of silent notifications on a user interface of the electronic device. In one or more embodiments, this detection involves querying the user settings to determine if the silent notification mode has been activated. The electronic device can check for a specific flag or setting that indicates the user's preference for receiving notifications in silent mode. If the flag is set, in one or more embodiments the system proceeds to the next step in the notification summarization process. If the flag is not set, in one or more embodiments the system continues with the device's default mode of operation.

Requiring an affirmative selection of the silent notification mode before actuating the notification summarization operation ensures that the user has explicitly chosen to receive notifications in a manner that minimizes disruptions. This approach respects the user's preference for a quieter notification experience, which can be particularly beneficial in environments where noise or visual distractions are undesirable, such as during meetings, while driving, or in low-light conditions. By requiring the user to enable this mode, the system avoids unintentional activation of silent notifications, thereby preventing potential confusion or missed alerts.

Additionally, the affirmative selection of the silent notification mode allows the user to maintain control over their notification settings, ensuring that the summarization operation aligns with their specific needs and preferences. This user-centric approach enhances the overall user experience by providing a tailored notification management system that adapts to the user's context and environment. The system also helps in reducing notification fatigue by presenting only the most relevant and prioritized notifications in a summarized format, thereby improving the efficiency of information consumption

Step 506, which is triggered when decision 505 determines the affirmative, comprises starting the notification history collection. In one or more embodiments, step 505 begins collecting notification data received by the device during the period when the user is engaged in the identified activity (exercising in this illustrative example). In one or more embodiments, this step 506 involves logging all incoming notifications to create a history that will be used for summarization. The collected data includes the content of the notifications, timestamps, and any other relevant metadata.

Step 506 can optionally include the assignment of a prioritization weight to each notification, ensuring that the notifications for the user are presented first. The weighting process can be based on various factors, such as the source of the notification, the content of the notification, and the user's past interactions with similar notifications. For instance, notifications from frequently contacted individuals or applications can be assigned higher weights, while less relevant notifications receive lower weights.

Several techniques can be applied to determine the prioritization weight of notifications. One approach involves using machine learning algorithms that analyze the user's interaction history with notifications. These algorithms can identify patterns and preferences, allowing the system to predict the importance of incoming notifications. Another technique involves natural language processing (NLP) to analyze the content of notifications, extracting phrases and determining the relevance based on predefined criteria. Additionally, user-defined rules can be implemented, where the user specifies certain keywords or contacts that are prioritized.

Each technique offers distinct advantages. Machine learning algorithms provide a dynamic and adaptive approach, continuously learning from the user's behavior to improve the accuracy of prioritization over time. NLP techniques offer a content-based analysis, ensuring that the most relevant information is highlighted based on the actual content of the notifications. User-defined rules provide a customizable solution, allowing users to have direct control over the prioritization process. By combining these techniques, the system can offer a comprehensive and effective method for managing notifications, ensuring that users receive the most important updates in a timely manner.

Decision 507 checks whether the artificial intelligence summary feature is enabled. If the artificial intelligence summary feature is enabled and a real-time summary is required, the system proceeds to summarize the notifications in an orderly manner. If a real-time summary is not required, the system continues to monitor the conditions and update the notification history.

Step 508 of FIG. 5 comprises presenting a notification summary on a user interface of the electronic device. In one or more embodiments, this presentation occurs only if decision 510 indicates that the device has become stationary, which suggests that the exercise may have stopped. Techniques for determining whether the device has become stationary include using accelerometers and gyroscopes to detect the absence of motion. These sensors can measure the device's movement and orientation, providing data that can be analyzed to determine if the device is no longer in motion. Another technique involves using GPS data to confirm that the device's location remains constant over a predefined period, indicating that the user has stopped moving.

Each technique offers distinct benefits. Using accelerometers and gyroscopes provides real-time and highly accurate motion detection, ensuring that the system can promptly identify when the user has stopped exercising. This method is particularly effective for detecting subtle movements and changes in orientation, making this method suitable for various physical activities. GPS data offers a broader context by confirming the device's stationary state over a larger area, which can be useful in scenarios where the user may have stopped moving but is still in a dynamic environment, such as a crowded gym or park.

If the device is not stationary, as determined at decision 510, or if the real-time summary mode of operation is not enabled, as determined by decision 507, the method continues to monitor device and user motion at step 509. This continuous monitoring ensures that the system remains responsive to changes in the user's activity and environment, allowing for the timely presentation of the notification summary once the appropriate conditions are met. This approach minimizes unnecessary interruptions and ensures that the user receives a concise and relevant summary of notifications only when the timing is most appropriate.

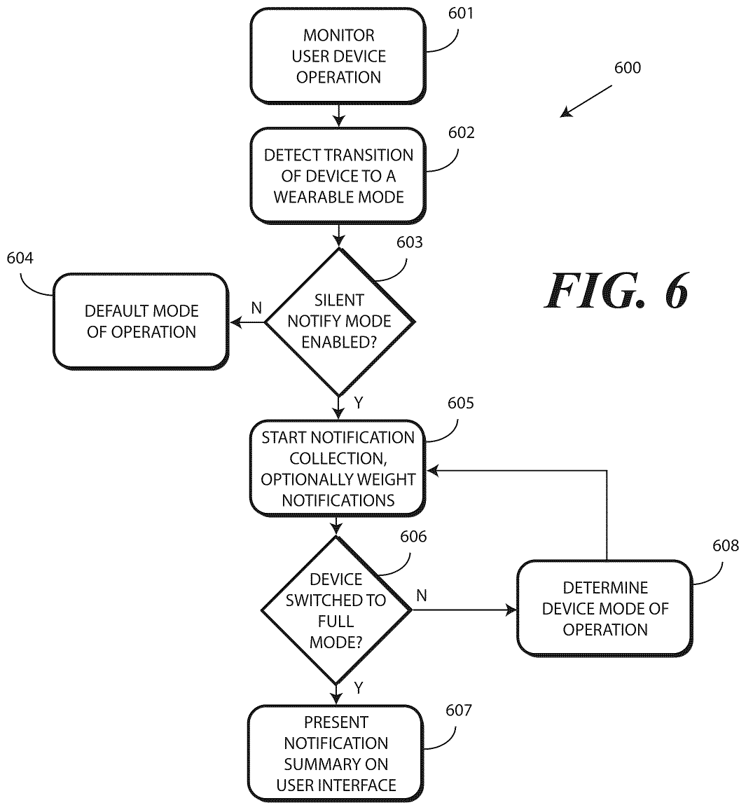

Turning now to FIG. 6, illustrated therein is yet another method 600 in accordance with one or more embodiments of the disclosure. FIG. 6 illustrates a method 600 for triggering a notification summarization operation based on user and device state. The method 600 involves several steps and decisions that facilitate the automatic AI-based notification summarization.

Step 601 involves monitoring user device operation. In one or more embodiments, step 601 comprises receiving data from various sensors of the electronic device to monitor user device information. The sensors can include light sensors, accelerometer sensors, gyroscope sensors, and location sensors. The light sensors can detect the ambient light levels in the environment surrounding the device, while the accelerometer sensors can measure the device's movement and orientation. The gyroscope sensors provide additional data on the device's rotational movement, and the location sensors determine the device's geographical position. An image capture device can capture images for processing that depict a user engaged in an activity or interacting with the electronic device. In one or more embodiments, these sensors provide input data that the system uses to determine the current state of the device and the user.

Step 602 of FIG. 6 determines whether an electronic device has been transformed to a wearable mode of operation. In one or more embodiments, this step 602 comprises analyzing data from various sensors integrated within the device. This transformation can occur through several mechanisms, including placing the electronic device in a holder strapped to an arm or leg or bending a bendable electronic device around a body part such as a wrist. The detection of these transformations relies on specific sensor inputs and processing algorithms designed to identify changes in the device's physical state and orientation.

When the electronic device is placed in a holder strapped to an arm or leg, accelerometers and gyroscopes detect the motion patterns associated with these body parts. For instance, the rhythmic swinging motion of an arm during walking or running can be distinguished from other types of movement. Additionally, proximity sensors and skin sensors can confirm the device's contact with the skin, further validating the device's placement in a wearable holder. This combination of motion and proximity data ensures accurate detection of the wearable mode, allowing the device to adjust the device's operation accordingly.

In the case of a bendable electronic device, the transformation to a wearable mode, such as wrapping around a wrist, can be detected through flex sensors and strain gauges embedded in the device. These sensors measure the degree of bending and deformation, providing real-time data on the device's shape. When the device bends to a predefined curvature, the system recognizes the wearable configuration. This method offers the advantage of flexibility, enabling the device to adapt to various body parts and conform to different shapes, enhancing user comfort and convenience.

Techniques for determining the transformation from a mode to a wearable mode offer distinct benefits. The use of motion and proximity sensors for devices in holders ensures precise detection based on movement patterns and skin contact, making the system ideal for activities like exercising. The flex sensor approach for bendable devices provides versatility, allowing the device to be worn in multiple configurations, such as around the wrist or other body parts. This adaptability enhances the device's usability in diverse scenarios, from fitness tracking to hands-free operation, ensuring a seamless and efficient user experience.

Decision 603 detects whether a user of the electronic device has enabled, using user settings of the electronic device, the presentation of silent notifications on a user interface of the electronic device. In one or more embodiments, this detection involves querying the user settings to determine if the silent notification mode has been activated. The electronic device can check for a specific flag or setting that indicates the user's preference for receiving notifications in silent mode. If the flag is set, in one or more embodiments the system proceeds to the next step in the notification summarization process. If the flag is not set, in one or more embodiments the system continues with the device's default mode of operation at step 604.

Step 605, which is triggered when decision 603 determines the affirmative, comprises starting the notification history collection. In one or more embodiments, step 605 begins collecting notification data received by the device during the period when the user is engaged in the identified activity (exercising in this illustrative example). In one or more embodiments, this step 506 involves logging all incoming notifications to create a history that will be used for summarization. The collected data includes the content of the notifications, timestamps, and any other relevant metadata.

Step 605 can optionally include the assignment of a prioritization weight to each notification, ensuring that the notifications for the user are presented first. The weighting process can be based on various factors, such as the source of the notification, the content of the notification, and the user's past interactions with similar notifications. For instance, notifications from frequently contacted individuals or applications can be assigned higher weights, while less relevant notifications receive lower weights.

Several techniques can be applied to determine the prioritization weight of notifications. One approach involves using machine learning algorithms that analyze the user's interaction history with notifications. These algorithms can identify patterns and preferences, allowing the system to predict the importance of incoming notifications. Another technique involves natural language processing (NLP) to analyze the content of notifications, extracting phrases and determining the relevance based on predefined criteria. Additionally, user-defined rules can be implemented, where the user specifies certain keywords or contacts that are prioritized.

Each technique offers distinct advantages. Machine learning algorithms provide a dynamic and adaptive approach, continuously learning from the user's behavior to improve the accuracy of prioritization over time. NLP techniques offer a content-based analysis, ensuring that the most relevant information is highlighted based on the actual content of the notifications. User-defined rules provide a customizable solution, allowing users to have direct control over the prioritization process. By combining these techniques, the system can offer a comprehensive and effective method for managing notifications, ensuring that users receive the most important updates in a timely manner.

Decision 606 determines whether the electronic device has been transformed out of the wearable mode to a mode of operation by analyzing data from various sensors integrated within the device. These sensors can include accelerometers, gyroscopes, proximity sensors, and flex sensors. The accelerometers and gyroscopes detect changes in the device's movement and orientation, while the proximity sensors and flex sensors measure the device's physical state and contact with the user's skin. By processing this sensor data, the system can accurately identify whether the device has transitioned from a wearable configuration, such as being strapped to an arm or wrapped around a wrist, to a mode of operation where the device is no longer in contact with the user's body or has returned to a flat, non-bendable state.

Step 607 presents the summarized notifications on a user interface of the electronic device when the first state of the electronic device ceases to meet the at least a first criterion of being in a wearable mode. This presentation involves displaying a concise and prioritized summary of notifications that were collected and processed while the device was in the wearable mode. The summarized notifications are organized based on their assigned weights, ensuring that the most important and relevant information is highlighted for the user. This step allows the user to quickly catch up on important communications without being overwhelmed by a flood of individual notifications, providing a streamlined and efficient notification management experience.

If decision 606 determines that the electronic device is still in a wearable state, step 608 continues to monitor the mode of operation. This continuous monitoring involves analyzing real-time data from the sensors to detect any changes in the device's state. The system remains responsive to transitions between wearable and other modes, ensuring that the notification summarization operation is triggered when specific conditions are met. This approach minimizes unnecessary interruptions and ensures that the user receives a concise summary of notifications when the timing is appropriate, enhancing the overall user experience.

FIG. 7 illustrates a method 700 of enabling a notification summary mode of operation based upon detecting an electronic device is in a pocket. The method 700 with one or more sensors of the electronic device detect that the device is in a pocket. This detection can involve various sensors, such as proximity sensors, light sensors, and motion sensors, which collectively determine the enclosed condition of the device. For instance, the light sensors may detect a significant reduction in ambient light, while the motion sensors may identify the characteristic motion patterns associated with placing the device in a pocket.

The one or more processors of the electronic device, in response to the detection of the pocket state, can then initiate the notification summary mode of operation. In one or more embodiments, this mode involves collecting incoming notifications and summarizing them using artificial intelligence-based text summarization models. The summarization process prioritizes notifications based on their importance to the user, ensuring that the most relevant information is highlighted. The summarized notifications are then stored for later presentation.

The method 700 can even continuously monitor the state of the electronic device to determine when the electronic device is removed from the pocket. The sensors detect changes in light levels, motion patterns, and proximity, indicating that the device is no longer in an enclosed condition. Once the device is removed from the pocket, the one or more processors terminate the notification summary mode and present the summarized notifications on the user interface. This presentation allows the user to quickly review important communications without being overwhelmed by a flood of individual notifications.

Enabling a notification summary mode based on detecting the device is in a pocket is beneficial for several reasons. First, the notification summary mode reduces the cognitive load on the user by providing a concise and prioritized summary of notifications, which can be quickly reviewed when the device is accessible. This approach minimizes distractions and ensures that the user does not miss important communications while the device is in a pocket. Additionally, the method enhances user safety by reducing the need to frequently check the device, particularly in situations where doing so may be inconvenient or unsafe, such as while walking or driving.

At step 701 of the method 700, a user 713 is using the electronic device 100 by holding it in the hand. The electronic device 100 therefore is not in an enclosed condition. It is instead in free space, with only the user's hand touching the electronic device 100.

At step 702, the user begins placing the electronic device in a pocket. One or more sensors operable with the one or more processors detect this transition from open air to an enclosed condition, i.e., an in-pocket condition in this example. For example, an accelerometer may detect, at step 702, the electronic device being lowered from the user's head toward a pocket. Other techniques for detecting enclosed conditions will be obvious to those of ordinary skill in the art having the benefit of this disclosure.

At step 703 of the method 700, the one or more processors, operating with the one or more sensors, detect that the electronic device is in an enclosed position or disposed within a repository container. In this illustrative example, the repository container enclosing the electronic device is the user's pocket 714. However, it should be noted that a pocket 714 is merely one type of repository container into which an electronic device 100 can be placed to create an enclosed condition. Purses, backpacks, cases, briefcases, attachés, drawers, and other repository containers can also create enclosed conditions for the electronic device 100.

At step 704 of FIG. 7, the user begins exercising while the electronic device is situated in her pocket. The user decides to go out for a run to establish a good cardiovascular habit. As she starts her run, the electronic device detects the motion associated with running through the accelerometer and gyroscope sensors at step 705. In one or more embodiments, these sensors capture the rhythmic motion patterns characteristic of running, allowing the device to recognize that the user is engaged in physical activity at decision 706. The light sensors also detect the ambient light levels, confirming that the device is in a pocket, as the light levels are significantly reduced. During her run occurring at step 704, the user even passes by Buster's Chicken Stand and waves to Chuck, who is enjoying his meal from step (105) of FIG. 1.

In one or more embodiments, decision 706 determines a first state of the electronic device and second state of a user interacting with the electronic device. Illustrating by example, in one or more embodiments decision 706 determines whether the user's speed is above a predefined threshold and whether the ambient light level is below a threshold. The sensors, including accelerometers and light sensors, provide data that the system uses to evaluate these conditions.

If both conditions are met, the system indicates that the user is engaged in a physical activity while the electronic device is in a low-light environment, which in this example is the case because the device is in a pocket. Since this is true, the activation of the notification summarization feature is triggered at step 708. Said differently, when decision 796 determines whether the first state meets at least a first criterion and whether the second state meets at least a second criterion, step 708 comprises triggering, by the one or more processors, an artificial intelligence (AI)-based notification summarization operation within the electronic device. If either condition is not met, the system proceeds to continue with the device's default mode at step 707.

Step 709 involves starting the notification history collection. The system begins collecting notification data received by the device during the period when the user is engaged in the identified activity. This step involves logging all incoming notifications to create a history that will be used for summarization. The collected data includes the content of the notifications, timestamps, and any other relevant metadata. The system assigns a prioritization weight to each collected notification, ensuring that the most important notifications are highlighted in the summary.

In one or more embodiments, step 709 also comprises summarizing the notifications in an orderly manner. In one or more embodiments, the system uses AI-based text summarization models to process the collected notification data. The models analyze the content of each notification, extract the most relevant information, and generate a concise summary. The notifications are then organized based on their assigned weights, ensuring that the most important notifications are presented first. This step ensures that the user receives a clear and prioritized summary of all missed notifications.

Step 710 continues to monitor the user and the electronic device so decision 711 can determine whether one or both of the first state ceases to meet the at least a first criterion and/or the second state ceases to meet the at least a second criterion. In one or more embodiments, decision 711 determines whether the first state meets the at least a third criterion and/or the second state meets the at least a fourth criterion. Illustrating by example, in this example, the third criterion comprises the electronic device being situated in an illuminated environment, e.g., being taken out of the pocket, and the fourth criterion comprises one or more of engagement in a rest activity or a user proximity with the electronic device for at least a predefined duration. In one or more embodiments, when this occurs, i.e., when the first state meets the at least a third criterion and/or the second state meets the at least a fourth criterion, step 712 comprises presenting, by the one or more processors, the notification summary on a user interface of the electronic device.

In one or more embodiments, step 712 presents the summarized notifications in a format that is easy to read and understand, allowing the user to quickly catch up on important communications without being overwhelmed by a flood of individual notifications. This step 712 marks the completion of the notification summarization process, providing the user with a streamlined and efficient way to manage missed notifications.

Accordingly, using the method 700 of FIG. 7, the electronic device continues to monitor the user's activity and collects incoming notifications. The AI-based notification summarization system processes these notifications, creating a concise and prioritized summary. This summary ensures that the user receives only the most relevant information, minimizing distractions and allowing her to focus on her run. The system updates the summary in real-time, incorporating new notifications as they arrive.

Once the user completes her run and removes the electronic device from her pocket, the sensors detect the change in state. The device then presents the summarized notifications on the user interface, allowing the user to quickly review important communications without being overwhelmed by a flood of individual notifications. This efficient management of notifications ensures that the user can stay informed while maintaining her focus on establishing a good cardiovascular habit.

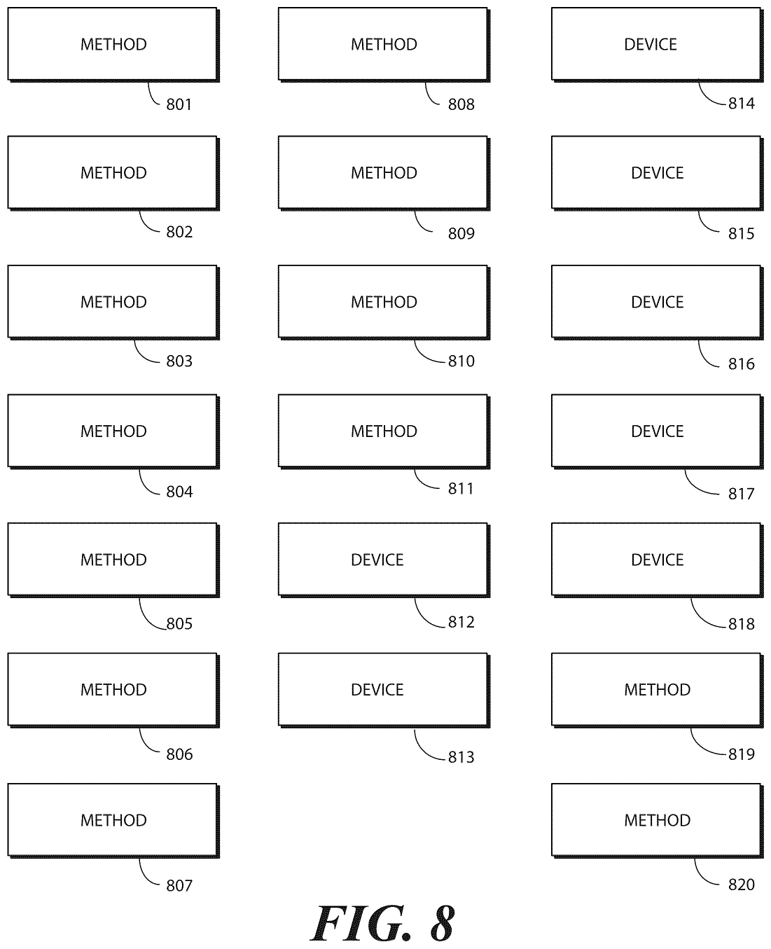

Turning now to FIG. 8, illustrated therein are various embodiments of the disclosure. The embodiments of FIG. 8 are shown as labeled boxes in FIG. 8 due to the fact that the individual components of these embodiments have been illustrated in detail in FIGS. 1-7, which precede FIG. 8. Accordingly, since these items have previously been illustrated and described, their repeated illustration is no longer essential for a proper understanding of these embodiments.

Thus, the embodiments are shown as labeled boxes.

At 801, a method in an electronic device comprises detecting, by one or more sensors of the electronic device, a first state of the electronic device and a second state of a user interacting with the electronic device. At 801, the method comprises determining, by one or more processors of the electronic device, whether the first state meets at least a first criterion and whether the second state meets at least a second criterion. At 801, the method comprises, where the first state meets the at least a first criterion and the second state meets the at least a second criterion, triggering actuation, by the one or more processors, of a notification summarization operation within the electronic device.

At 802, the notification summarization operation of 801 collects and summarizes notifications received by a communication device of the electronic device while the first state meets the at least a first criterion and the second state meets the at least a second criterion. At 803, the notification summarization operation of 802 further assigns a prioritization weight to each notification of the notifications received by the communication device of the electronic device while the first state meets the at least a first criterion and the second state meets the at least a second criterion. At 804, the prioritization weight of 803 is a function of an importance of the each notification to the user interacting with the electronic device.

At 805, the at least a first criterion of 802 comprises one or more of a first device housing of the electronic device being pivoted relative to a second device housing to a closed position, a display of the electronic device being placed in an adaptive display mode of operation, the electronic device being placed in a low-ambient light environment, the electronic device being in an enclosed condition, and/or the display of the electronic device being occluded by an object situated proximately with the display of the electronic device. At 806, the enclosed condition of 805 comprises the electronic device being positioned within a pocket.

At 807, the at least a second criterion of 802 comprises one or more of engagement in a physical activity or a lack of proximity with the electronic device for at least a predefined duration. At 808, the method of 802 further comprises summarizing, by the one or more processors, the notifications received by the communication device of the electronic device while the first state meets the at least a first criterion and the second state meets the at least a second criterion to create a notification summary.

At 809, the method of 808 further comprises terminating, by the one or more processors, the notification summarization operation when one or both of the first state ceases to meet the at least a first criterion and/or the second state ceases to meet the at least a second criterion. At 809, the method comprises presenting, by the one or more processors, the notification summary on a user interface of the electronic device.

At 810, the presenting of 809 occurs only when the first state meets the at least a third criterion and/or the second state meets the at least a fourth criterion. At 811, the third criterion of 810 comprises the electronic device being situated in an illuminated environment and the fourth criterion comprises one or more of engagement in a rest activity or a user proximity with the electronic device for at least a predefined duration.

At 812, an electronic device comprises one or more sensors, a user interface, and one or more processors operable with the one or more sensors and the user interface. At 812, the one or more processors, in response to the one or more sensors detecting a predefined device state, collect notification data and summarize the notification data to generate summarized notifications while the predefined device state is occurring, and cause the user interface to present the summarized notifications when occurrence of the predefined device state ceases as detected by the one or more sensors.

At 813, the predefined state of 812 comprises the electronic device being positioned in a pocket. At 814, the predefined state of 813 further comprises the electronic device moving in accordance with a walking motion or a running motion.

At 815, the predefined state of 812 comprises the electronic device being transitioned to a wearable state. At 816, the predefined state of 812 comprises the electronic device being positioned in a low-light environment.

At 817, the one or more processors of 812 further prioritize the notification data by assigning a prioritization weight to each notification of the notification data, with the prioritization weight being a function of an importance of each notification to a user interacting with the user interface of the electronic device. At 818, the one or more processors of 812 further terminate the generation of the summarized notifications when the electronic device exits the predefined device state and present the summarized notifications on the user interface when the electronic device enters another predefined device state that is different from the predefined device state.

At 819, a method in an electronic device comprises detecting, by one or more sensors of the electronic device, a first state of the electronic device and a second state of a user interacting with the electronic device. At 819, the method comprises determining, by one or more processors of the electronic device, whether the first state meets at least a first criterion and whether the second state meets at least a second criterion

At 819, the method comprises triggering, by the one or more processors, an artificial intelligence (AI)-based notification summarization operation within the electronic device when the first state meets the at least a first criterion and the second state meets the at least a second criterion. At 819, the method comprises collecting, by the one or more processors, notification data received by the electronic device during the AI-based notification summarization operation

At 819, the method comprises summarizing, by the one or more processors, collected notification data to generate summarized notifications. At 819, the method comprises presenting, by the one or more processors, the summarized notifications on a user interface of the electronic device when the first state ceases to meet the at least a first criterion and/or the second state ceases to meet the at least a second criterion. At 820, the first state of 819 comprises the electronic device being transported in a wearable configuration and the second state comprises the user being engaged in physical activity.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
detecting, by one or more sensors of the electronic device, a first state of the electronic device and a second state of a user interacting with the electronic device;
determining, by one or more processors of the electronic device, whether the first state meets at least a first criterion and whether the second state meets at least a second criterion; and
where the first state meets the at least a first criterion and the second state meets the at least a second criterion, triggering actuation, by the one or more processors, of a notification summarization operation within the electronic device.

2. The method of claim 1, wherein the notification summarization operation collects and summarizes notifications received by a communication device of the electronic device while the first state meets the at least a first criterion and the second state meets the at least a second criterion.

3. The method of claim 2, wherein the notification summarization operation further assigns a prioritization weight to each notification of the notifications received by the communication device of the electronic device while the first state meets the at least a first criterion and the second state meets the at least a second criterion.

4. The method of claim 3, wherein the prioritization weight is a function of an importance of the each notification to the user interacting with the electronic device.

5. The method of claim 2, wherein the at least a first criterion comprises one or more of a first device housing of the electronic device being pivoted relative to a second device housing to a closed position, a display of the electronic device being placed in an adaptive display mode of operation, the electronic device being placed in a low-ambient light environment, the electronic device being in an enclosed condition, and/or the display of the electronic device being occluded by an object situated proximately with the display of the electronic device.

6. The method of claim 5, wherein the enclosed condition comprises the electronic device being positioned within a pocket.

7. The method of claim 2, wherein the at least a second criterion comprises one or more of engagement in a physical activity or a lack of proximity with the electronic device for at least a predefined duration.

8. The method of claim 2, further comprising summarizing, by the one or more processors, the notifications received by the communication device of the electronic device while the first state meets the at least a first criterion and the second state meets the at least a second criterion to create a notification summary.

9. The method of claim 8, further comprising:
terminating, by the one or more processors, the notification summarization operation when one or both of the first state ceases to meet the at least a first criterion and/or the second state ceases to meet the at least a second criterion; and
presenting, by the one or more processors, the notification summary on a user interface of the electronic device.

10. The method of claim 9, wherein the presenting occurs only when the first state meets the at least a third criterion and/or the second state meets the at least a fourth criterion.

11. The method of claim 10, wherein the third criterion comprises the electronic device being situated in an illuminated environment and the fourth criterion comprises one or more of engagement in a rest activity or a user proximity with the electronic device for at least a predefined duration.

12. An electronic device, comprising:
one or more sensors;
a user interface; and
one or more processors operable with the one or more sensors and the user interface;
wherein the one or more processors, in response to the one or more sensors detecting a predefined device state, collect notification data and summarize the notification data to generate summarized notifications while the predefined device state is occurring, and cause the user interface to present the summarized notifications when occurrence of the predefined device state ceases as detected by the one or more sensors.

13. The electronic device of claim 12, wherein the predefined device state comprises the electronic device being positioned in a pocket.

14. The electronic device of claim 13, wherein the predefined device state further comprises the electronic device moving in accordance with a walking motion or a running motion.

15. The electronic device of claim 12, wherein the predefined device state comprises the electronic device being transitioned to a wearable state.

16. The electronic device of claim 12, wherein the predefined device state comprises the electronic device being positioned in a low-light environment.

17. The electronic device of claim 12, wherein the one or more processors further prioritize the notification data by assigning a prioritization weight to each notification of the notification data, with the prioritization weight being a function of an importance of each notification to a user interacting with the user interface of the electronic device.

18. The electronic device of claim 12, wherein the one or more processors further terminate the generation of the summarized notifications when the electronic device exits the predefined device state and present the summarized notifications on the user interface when the electronic device enters another predefined device state that is different from the predefined device state.

19. A method in an electronic device, the method comprising:
detecting, by one or more sensors of the electronic device, a first state of the electronic device and a second state of a user interacting with the electronic device;
determining, by one or more processors of the electronic device, whether the first state meets at least a first criterion and whether the second state meets at least a second criterion;
triggering, by the one or more processors, an artificial intelligence (AI)-based notification summarization operation within the electronic device when the first state meets the at least a first criterion and the second state meets the at least a second criterion;
collecting, by the one or more processors, notification data received by the electronic device during the AI-based notification summarization operation;
summarizing, by the one or more processors, collected notification data to generate summarized notifications; and
presenting, by the one or more processors, the summarized notifications on a user interface of the electronic device when the first state ceases to meet the at least a first criterion and/or the second state ceases to meet the at least a second criterion.

20. The method of claim 19, wherein the first state comprises the electronic device being transported in a wearable configuration and the second state comprises the user being engaged in physical activity.
